(19) United States
(12) Patent Application Publication
(10) Pub. No.: US 2024/0232655 A9
(43) Pub. Date: Jul. 11, 2024

(54) PREDICTIVE MACHINE LEARNING ARCHITECTURE FOR IDENTIFYING GAPS IN NETWORK ACTIVITY

(71) Applicant: Visa International Service Association, San Francisco, CA (US)

(72) Inventors: Tomas Cacicedo, Coral Gables, FL (US); Arya Eskamani, Miami, FL (US); Debesh Kumar, Foster City, CA (US)

(73) Assignee: Visa International Service Association, San Francisco, CA (US)

(21) Appl. No.: 18/194,213

(22) Filed: Mar. 31, 2023

Related U.S. Application Data
(60) Provisional application No. 63/417,591, filed on Oct. 19, 2022.

(51) Int. Cl. G06N 5/022; G06N 3/08

(52) U.S. Cl. CPC G06N 5/022; G06N 3/08

(57) ABSTRACT

Systems and methods for classifying gaps in network activity as normal or anomalous are disclosed. A computer system can identify time gaps between successive network events, which can comprise communications or interactions between entities or devices on a network. The computer system can identify network event data records corresponding to network events that occurred both before and after the identified time gaps. The computer system can use data contained in network event data records corresponding to these network events to derive data features that can be used to train a machine learning to classify time gaps based on those features. After training the machine learning model, the computer system can then extract data features corresponding to unlabeled time gaps, and input those data features into the trained machine learning model in order to classify those time gaps as normal or anomalous.

### CROSS-REFERENCES TO RELATED APPLICATIONS

This application claims the benefit of U.S. Provisional Application No. 63/417,591, filed Oct. 19, 2022, which is herein incorporated by reference in its entirety for all purposes.

### BACKGROUND

Network activity, broadly refers to the use of a network by an entity or device. Examples of networks include cloud computing networks, social network websites, geolocation services (e.g., GPS based navigation services), payment processing networks, and the like. As an example, a user can be said to be “active” on a social network if they are logged into a website associated with the social network and can be said to be “inactive” if they are logged out. As another example, in a cloud computing network, a “worker node” can be said to be active on the network if it is communicating with other computers on the network and can be said to be inactive if it is not communicating with other computers on the network. A period of inactivity between two periods of activity can be referred to as a “gap” in network activity.

Gaps in network activity are not uncommon in many networks or network services. As an example, in a cloud computing network, a worker node may communicate with an orchestrator computer. The orchestrator computer may assign a task or program to the worker node, which the worker node may execute. A “gap” in network activity (e.g., a lack of communication between the worker node and orchestrator) may not be unusual if the worker node is working on its assigned task. As another example, in a social network a user may only log in a couple times per week. As such, a gap of two to three days between network events (logins) may not be considered unusual.

However, some gaps may be unusual or anomalous, and detecting such network activity gaps may be useful. For a cloud computing service, it may be helpful to determine whether gaps in network activity by a worker node are a result of the worker node working to complete its task, or a result of the worker node crashing and rebooting. As another example, some organizations may be interested in detecting gaps in network activity due to travel. Some network users may prefer to use different network resources while travelling out of their home country (e.g., different social networks, different geolocation services, different accounts associated with such services, etc.). This information may be useful to these organizations, as it may enable them to provide them with services that may closer align with their user's needs (e.g., geolocation services or social networks that are more useful for their users when those users travel out of the country).

However, it can be difficult to distinguish between normal gaps and anomalous gaps in network activity. At a high level, they can appear identical because they both appear as periods of time during which an entity is not active on a network. While statistics such as the length of a gap can be used to evaluate whether a gap is normal or anomalous (e.g., by defining normal gaps as being shorter than a certain time period and anomalous gaps as being longer than a certain time period), exceptions are somewhat common. For example, for a cloud computing system, a complex task may take much longer for a worker node to complete than a relatively simple task, and thus the length of the gap in network activity may not indicate whether that gap was normal (e.g., due to normal working activity of the worker node) or anomalous (e.g., due to a crash or failure by the worker node). As another example, a non-travelling user can infrequently use a resource without travelling (leading to a large network event gap), while another user could take a weekend trip out of the country, resulting in a gap of only two to three days. As such, the length of the gap may not indicate whether that gap was a result of travel. These examples identify some of the difficulties in distinguishing between normal or anomalous gaps in network activity.

Embodiments address these and other problems, individually and collectively.

### SUMMARY

Embodiments of the present disclosure are directed to methods and systems for detecting anomalous gaps in network activity, or alternatively for distinguishing between normal gaps in network activity and anomalous gaps in network activity. It should be understood that terms like “normal” or “anomalous” are intended to distinguish between classes of things (e.g., time gaps between “network events”), and are not intended to limit those things based on the conventional meaning of the terms “normal” and “anomalous”. What comprises a normal gap in network activity or an anomalous gap in network activity may depend on context and may be defined by a practitioner of methods according to embodiments. As such, it is not possible to define normal gaps and anomalous gaps in every possible context and use case. Instead, some examples are provided throughout the present disclosure, primarily relating to the context of cloud computing networks and payment processing networks.

For example, in the context of cloud computing, a gap in network activity caused by a worker node working on a computing task may be considered normal, while a gap in network activity caused by a worker node crashing and rebooting may be considered anomalous. In such a context, embodiments of the present disclosure could be used to detect whether gaps in network activity are caused by normal computing network activity or by worker node crashes. However, one could just as easily define a worker node crash as normal, and completion of a computing task as anomalous.

In some methods according to embodiments, a computer system can analyze “network event data records” corresponding to individual network events (e.g., logins to a social networking service, communications between a worker node and an orchestrator computer, transactions, etc.) in order to detect time gaps in network activity based on time differences between sequential network events. After identifying such time gaps, the computer system can extract features from network event data records corresponding to network events that took place before and after these gaps. These “pre-gap” and “post-gap” features can be used as the input to a machine learning model in order to classify each identified time gap as either normal or anomalous. The output classification of the machine learning model can then be used by interested parties for some purpose, which may depend largely on context. As an example, in a cloud computing network, if a network engineer detects anomalous time gaps corresponding to a particular worker node (e.g., due to crashes by that worker node), the engineer could then fix or replace that worker node in order to prevent such crashes.

In more detail, one embodiment is directed to a method performed by a computer system. The computer system can obtain (e.g., receive or generate) a plurality of training data samples. Each training data sample of the plurality of training data samples can provide (e.g., identify or comprise) (1) a training time gap between two training network events, where each network event can correspond to a respective network resource, (2) a training label indicating whether the training time gap comprises a normal time gap or an anomalous time gap, (3) a set of pre-gap features corresponding to training network events that took place before the training time gap, and (4) a set of post-gap features corresponding to training network events that took place after the training time gap. The computer system can use the plurality of training data samples to train a machine learning model to classify one or more input time gaps as normal or anomalous based on one or more sets of input pre-gap features and one or more sets of input post gap features. The computer system can retrieve an input data set comprising a plurality of network event data records corresponding to a first network resource, and can identify the one or more input time gaps within this input data set. For each input time gap of the one or more input time gaps, the computer system can determine a corresponding set of input pre-gap features and a corresponding set of input post-gap features. The computer system can then classify each of the one or more input time gaps as normal or anomalous by inputting each corresponding set of input pre-gap features and each corresponding set of input post-gap features into the machine learning model, thereby determining one or more classifications, each classification of the one or more classifications indicating whether a corresponding input time gap of the one or more input time gaps is classified as normal or anomalous.

Another embodiment is directed to a method performed by a computer system or one or more processors of a computer system. The computer system can receive historical access requests for a set of resources managed by a network, each historical access request including access data identifying a resource of the set of resources and including requestor information of a requestor. The computer system can identify a plurality of time periods in the historical access requests for when the historical access requests are made from devices outside of a specified geographic region. The computer system can generate a training set of the historical access requests that occur before and after each time period of the plurality of time periods. The computer system can extract a set of features from the access data of the training set of the historical access requests. The computer system can then train a machine learning model (using the set of features) to predict the time period when access requests occur from outside the specified geographic region based on a pattern of the training set of the historical access requests that occur before and after the time periods. The computer system can receive a first set of access requests for one or more first resources corresponding to a first request and managed by the network. The first set of access requests can include first access data identifying a first resource of the one or more first resources and can include first requestor information of the first requestor. The first set of access requests can include time gaps when no access requests occur. The computer system can extract a plurality of first features from the first access data of the first set of access requests. The computer system can then input the plurality of first features into the machine learning model in order to determine whether one or more of the time gaps occurred when the requestor was outside of the specified geographic region.

Another embodiment is directed to a computer system comprising one or more processors and a non-transitory computer readable medium coupled to the processor, the non-transitory computer readable medium comprising code or instructions, executable by the one or more processors for performing the above-noted methods and other methods.

Prior to describing embodiments in more detail, it may be helpful to review some terms used throughout this disclosure.

### BRIEF DESCRIPTION OF THE DRAWINGS

FIG. 1 shows two examples of network event data records.

FIG. 2 shows an example of a first time series of network events, including both normal network events and anomalous network events.

FIG. 3 shows an example of a second time series of network events, including normal network events but omitting anomalous network events.

FIG. 4 shows a diagram of a resource access control system, including a computer system that can be used to classify time gaps as normal or anomalous.

FIG. 5 shows a flowchart of an exemplary method of machine learning model training and time gap classification according to some embodiments.

FIG. 6 shows a diagram detailing an exemplary training time gap identification process according to some embodiments.

FIG. 7 shows a list of exemplary features that can be used to classify time gaps according to some embodiments.

FIG. 8 shows an exemplary computer system according to some embodiments.

### TERMS

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “memory” may refer to any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-seed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processors.

A “machine learning model” may refer to a program, file, method, or process used to perform some function on data based on knowledge “learned” during a “training phase.” In “supervised learning,” a machine learning model can learn correlations between features contained in feature vectors and associated labels, which may classify those feature vectors (e.g., as normal or anomalous). After training, the machine learning model can receive unlabeled feature vectors and generate corresponding labels or classifications based on training. For example, during a training process, a machine learning model can evaluate labelled images of dogs. After training, the machine learning model can evaluate unlabeled images, in order to determine of those images are of dogs. Accordingly, a “machine learning model” can refer to a software module configured to be run on one or more processors to provide a classification or a numerical value of a property of one or more samples. Supervised learning models may include different approaches and algorithms, including (for example), analytical learning, artificial neural networks, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifiers, maximum entropy classifiers, conditional random fields, nearest neighbor algorithms, probably approximately correct learning (PAC), ripple down rules, a knowledge acquisition methodology, symbolic machine learning algorithms, sub-symbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. A machine learning model may include linear regression, logistic regression, deep recurrent neural networks (e.g., long short term memory or LSTM), hidden Markov models (HMM), linear discriminant analysis (LDA), k-means clustering, density-based spatial clustering of applications with noise (DBSCAN), random forest algorithms, support vector machines (SVM), or any model described herein. Supervised models can be trained in various ways using various cost, loss, or error functions that define error from known labels (e.g., using least squares and absolute difference) and various optimization techniques, e.g., using backpropagation, steepest descent, conjugate gradient, and Newton and quasi-Newton techniques.

Machine learning models may be defined by “parameter sets,” comprising “parameters,” which may refer to numerical or other measurable factors that define something (e.g., a machine learning model) or the condition of that thing's operation. In some cases, training a machine learning model may comprise identifying a set of parameters that results in the best performance by the machine learning model. This can be accomplished using a “loss function,” or “error function,” which may refer to a function that relates a model's parameter set to a “loss value” or “error value,” a metric that relates the performance of a machine learning model to its expected or desired performance.

“Training data” may refer to data used to train a machine learning model, and can comprise “training data samples,” units of data used for training. In the context of supervised learning, a training data sample could comprise a feature vector (comprising data features) and an associated label, indicating a classification corresponding to that feature vector (e.g., indicating if that feature vector is an example of normal data or anomalous data). A collection of training data samples can be referred to as a “training data set.”

A “network” can refer to a group or system of interconnected things. An example of a network is a cloud computing network, a connected system of computer systems used to perform computing tasks or operations. Another example of a network is a payment processing network (such as the Visa payment processing network), a connected network of issuers, acquirers, merchants, and users that enables payments between users and merchants, e.g., in the form of credit card transactions. A “network event” can refer to some action or interaction that takes place on a network. For example, a credit card transaction is an example of a network event in a payment processing network. A “network event data record” can refer to a collection of data relating to a network event, which can be stored in a database. For example, a network event data record relating to a credit card transaction could include a “timestamp,” or “time value” indicating the time at which that credit card transaction took place.

A “time gap” can refer to a period of time between two events, such as network events. For example, in the context of a payment processing network in which a network event comprise a credit card transaction, a time gap can comprise the period of time between two successive credit card transactions. Time gaps can also be between non-successive network events. For example, an “anomalous time gap” can be between two normal network events with some number of intervening anomalous network events. Events occurring before a time gap can be referred to as “pre-gap” events (e.g., pre-gap network events), while events occurring after a time gap can be referred to as “post-gap” events.

A “message” may refer to any information that may be communicated between entities. A message may be communicated by a “sender” to a “receiver.” A sender may refer to any originator of a message and a receiver may refer to any recipient of a message. Most form of digital data (including e.g., text files, video files, cryptographic keys, etc.) can be represented as messages.

A “user” may refer to an entity that uses something for some purpose. An example of a user is a person who uses a “user device” or a “mobile device.” A user device may refer to any device operated by a user, such as a smartphone, smartcard, wearable device, laptop, tablet, desktop computer, etc. In contexts where users are making requests (e.g., requests for resources held by resource providers), a user may be referred to as a “requestor.” In the context of a payment processing network, a user device may comprise a credit card, and a user may be referred to as a “cardholder.”

“Authentication” may refer to the process or action of proving or showing something to be true, genuine, or valid. Authenticating a user may refer to the process of verifying the identity of the user, e.g., verifying that the user is who they claim to be.

A “resource provider” may refer to an entity that provides a “resource.” The term “resource” generally refers to any asset that can be used or consumed. Resources can include “electronic resources” or “computer resources,” such as stored data (e.g., a digital video file corresponding to a feature film), a networked computer account, or communications between computers (e.g., a communication signal corresponding to an account for performing a transaction Resources can also include accounts, such as a credit card account. Resources associated with a network may be referred to as “network resources.” Access to something (such as a secured location) may also qualify as a resource. Entities associated with such networks (e.g., users), can make “access requests” over those networks for resources. For example, a user can use a user device to send an access request over a network, in order to get access to their user account. Examples of resource providers include merchants, government entities, etc. A resource provider may operate a “resource provider computer.”

A “transport computer” may refer to a computer system that transports data from one computer to another computer. A transport computer may comprise an intermediary in a computer network such as the internet. In some cases, a transporter computer may be operated by an “acquiring entity” or an “acquiring bank,” an entity that performs banking services on behalf of a resource provider (e.g., a merchant).

An “authorization computer” may refer to a computer system that is used to authorize some action or interaction between entities. For example, an authorization computer can be used to authorize a transaction between a user and a (merchant) resource provider. In some cases, an authorization computer may be operated by an “issuing entity” or “issuing bank,” an entity that performs banking services on behalf of a user. The owner or operator of an authorization computer may be referred to as an authorizing entity. For example, an issuing bank can comprise an authorizing entity.

A “processing computer” may refer to a computer system that processes data or messages transmitted between computers in a network. As an example, a processing computer can receive messages, determine their intended recipient, and transmit those received messages to their intended recipient. A processing computer can comprise part of a “processing network,” such as a “payment processing network,” which can facilitate payments between entities by routing authorization request messages and authorization response messages to their intended recipients, as well as facilitating clearing and settlement services.

A “database” may refer to a structured set of data held or stored in a computer or other device. Alternative, a database may refer to a device which hold such a structured set of data. A “data record” may refer to a unit of data stored in a database. For example, a “network event database” may store network event data records corresponding to network events occurring in or on a network. Data stored in a database may be in the form of a “data table”, an arrangement of data in rows, columns, or more complex structures. Data tables may comprise “key value” pairings, in which “values” (e.g., numerical values, strings, or any other data) are associated with corresponding “keys” (e.g., labels corresponding to those values). Databases can be parsed (e.g., searched or queried) or sorted based on the values corresponding to keys, e.g., using query languages such as SQL.

An “access device” may refer to a device used to access something, such as a network or computer system. For example, a point of sale terminal can comprise an access device used to gain access to a payment processing network. An access device may comprise a means by which it can interface with other devices. For example, an access device may include a “chip card reader,” including conductive contacts used to interface with a smartcard user device. An access device can be used to make “access requests”, such as access to resources like goods, services, or accounts.

A “credential” may refer to a qualification (e.g., data) indicating that something (e.g., a user) is suitable for something. For example, a credential can be used to indicate that a user is authorized to perform a credit card transaction. A credit card number or “payment account number” is an example of a credential. In some cases an “identifier,” data that may be used to identify something, such as an entity, computer, device, account, etc., may be used as a credential. Examples of identifiers include names, social security numbers, serial numbers, SIM numbers, credit card numbers, account numbers, usernames, etc. A “user device identifier” may refer to an identifier that can be used to identify a particular user device.

### DETAILED DESCRIPTION

Some embodiments of the present disclosure are directed to methods and systems for classifying gaps in network activity (e.g., periods of time between network events) as normal or anomalous. A computer system can instantiate, train, and use a machine learning model in order to classify these gaps. Methods according to embodiments may be particularly useful in the context of payment processing network activity, particularly related to gaps due to travel. In such contexts, a network event may comprise an interaction (e.g., a transaction) performed using a credential (e.g., a credit card number, payment account number, etc.) between a user (e.g., a cardholder) and a resource provider (e.g., a merchant), optionally via a user device (e.g., a credit card, a payment enabled smartphone or wearable device, a laptop computer, etc.). In such a context, a normal network event can comprise a domestic credit card transaction, e.g., a credit card transaction made within the country or geographic region where a credit card was issued. By contrast, an anomalous network event can comprise an international credit card transaction, e.g., a credit card transaction made outside the country or geographic region where the credit card was issued.

In this context, gaps in network activity may be defined as periods of time between successive domestic credit card transaction network events made using the credential. Using methods and systems according to embodiments, it is possible to determine whether time gaps in network activity correspond to periods of international travel (which may be referred to as “anomalous time gaps”) or do not correspond to periods of international travel (which may be referred to as “normal time gaps”). This could be useful to authorizing entities (e.g., issuing banks) or payment processing network organizations (e.g., credit card companies), which may wish to identify cardholders that are not using their credit cards during travel, in order to offer those cardholders incentives or promotions to do so.

Prior to describing embodiments, it may be helpful to describe concepts such as network activity, network events and machine learning in more detail. Network activity can be characterized or quantified using “network events” or statistics derived from those network events, such as the frequency of network events over a given period of time. As an example, a network in which network events occur more frequently can be said to have greater network activity than a network in which network events occur less frequently. As defined above, a network event can refer to an interaction between something (e.g., an entity, device, object, or data) and a network, or with another thing (e.g., another entity, device, object, or data) associated with that network. Network events can depends on the nature of the network associated with those network events. As an example, in a cloud computing network, a network event can comprise a communication between a worker computer node and an orchestrator computer node. In the context of a geolocation network, a network event can comprise a communication between a GPS receiver (e.g., installed in a delivery vehicle) and a GPS satellite. In the context of a payment processing network, a network event can correspond to a transaction made using a credit card and could relate to all activities or communications related to that transaction. This can include, for example, sliding or inserting a credit card into a point of sale terminal, transmitting an authorization request message to an issuing bank, etc.

Network events can be described, recorded, and analyzed using “network event data records.” Such network event data records can contain data that facilitates the detection of time gaps. For example, network event data records can contain timestamps or time values that can be used to determine a time gap between two network events. Further, network event data records corresponding to network events both before and after a time gap can contain data that can be used to classify that time gap as normal or anomalous. For example, in the context of a payment processing network, domestic credit card transactions (network events) before and after a time gap (e.g., a period of time during which no domestic credit card transactions took place) may indicate whether the cardholder travelled internationally during that time gap. As an example, cardholders can spend more on taxi services before and after international travel (e.g., in order to get to and from the airport). As a consequence, a cardholder's spending on taxi services before and after a time gap may be useful feature for classifying that time gap as normal or anomalous.

### I. Network Event Data Model

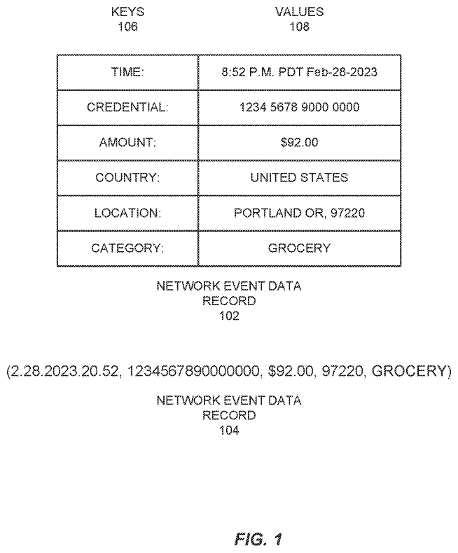

As described above, network events can be qualified, quantified, or described using “network event data records.” As described further below, data contained in these network event data records (or features derived from such data) can be used to classify time gaps between network events as normal or anomalous. Each network event data record can comprise data corresponding to a particular network event. As an example, for a cloud computing network, a network event data record could correspond to a particular communication between a worker node and an orchestrator node, and could comprise, e.g., a timestamp, a worker node identifier, an orchestrator node identifier, data related to the completion of a computing task, etc. In the context of a payment processing network, a network event data record could comprise data related to a credit card transaction, such as a timestamp associated with the transaction, an amount associated with the transaction, a transaction category (e.g., groceries), etc. Two examples of network event data records 102 and 104 are shown in FIG. 1, corresponding to a hypothetical transaction that took place on Feb. 28, 2023.

Network event data records can have any appropriate form. As an example, exemplary network event data record 102 comprises a table of “key-value” relationships between keys 106 and values 108. For example, the “TIME” key is associated with a value “8:52 P.M. PDT Feb-28-2023”, which may indicate that a network event took place at the time and date specified by the data value. Likewise, the “CREDENTIAL” key is associated with a data value “1234 5678 9000 0000” (e.g., a credit card number), and the “AMOUNT” key is associated with a data value “$92.00,” which can indicate an amount spent during that network event. FIG. 1 also shows an alternative form of a network event data record 104, comprising a tuple or list of data values. It should be understood that the network event data records 102 and 104 are presented only as examples, and, as stated above, network event data records can take any appropriate form.

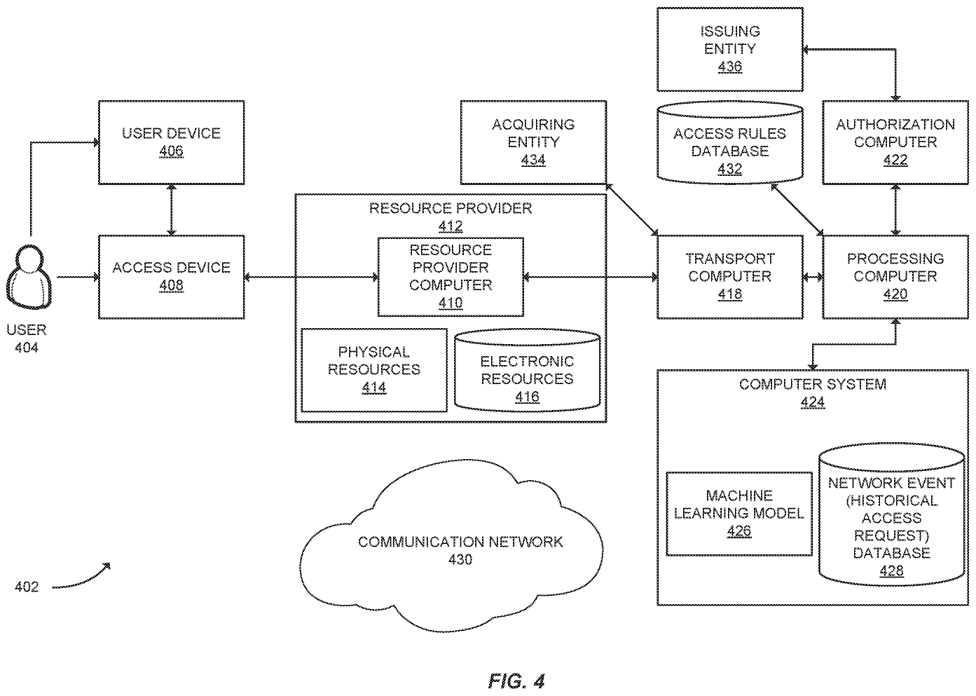

In some embodiments, network event data records can contain “requestor information,” which may correspond to a requestor (e.g., a user or cardholder) and which may include a requestor credential associated with the requestor (e.g., the data value associated with the “CREDENTIAL” key) or a requestor identifier associated with the requestor (e.g., the name of the requestor, a user name, etc.). Further, network event data records can correspond to “access requests,” such as requests for a resource in a “resource access control system” (such as the exemplary resource access control system described in FIG. 4). An example of an access request is an authorization request message, sent by an access device (e.g., a point of sale terminal) to an issuing bank (via, e.g., a payment processing network) to request authorization for a transaction between a requestor (cardholder) and a resource provider (merchant). In some cases, a network resource (such as a “first network resource”) can comprise a user account (such as a “first user account”) associated with a user. In such cases, an access request may indicate that the user wants to access their user account for some purpose. In the context of a payment processing network, a user account could comprise a credit account associated with a credit card holder, and the user may request access to such an account in order to make a credit card payment to a merchant.

Network event data records can be organized into sets, i.e., groups or collections containing one or more network event data records. Network event data records can be organized into sets based on common characteristics of those network event data records. For example, for a payment processing network, all network event data records corresponding to a particular credential (e.g., a payment account number) or a particular cardholder can be grouped into a set, while all network event data records corresponding to a different credential or a different cardholder can be grouped into a different set. As another example, all network event data records corresponding to network events occurring on a particular day (e.g., February 28^{th}) can be grouped into a set, while all network event data records corresponding to network events that occurred on a different day can be grouped into another set. As another example, for a cloud computing network, all network event data records corresponding to a particular worker node can be grouped into a set. A network event data record can be a member of multiple sets. For example, network event data record 102 could be a member of a set corresponding to network event data records related to credential “1234 5678 9000 0000” and a different set corresponding to network event data records related to the date Feb. 28, 2023. When stored in a database (or other suitable data structure), network event data records can be indexed or sorted based on sets that they are members of. This indexing or sorting may accelerate or make the process of identifying relevant network event data records more efficient, e.g., during a training process as described below.

Generally, a network event data record can contain or otherwise be associated with a time value or timestamp, a value that indicates a time at which a corresponding network event took place. Such time values or timestamps can be used to chronologically sort network event data records.

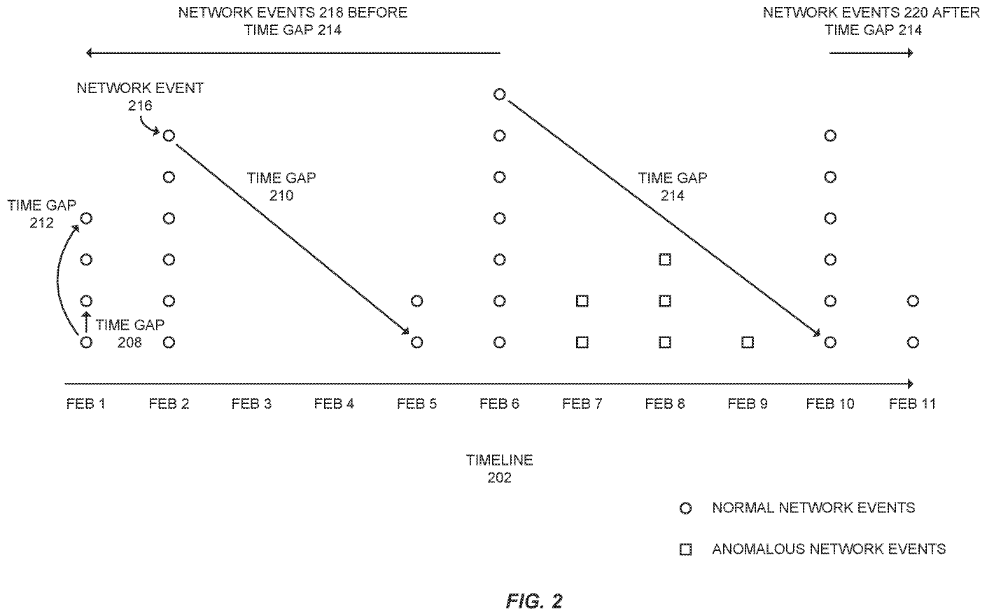

FIG. 2 shows a timeline 202 of exemplary network events that took place between February 1^{st} and February 12^{th} listed chronologically. In this timeline 202, multiple network events take place on the same days, for example six network events took place on February 2^{nd}, the last of which (i.e., the network event taking place at the latest time on February 2^{nd}) is network event 216.

FIG. 2 also includes two different classes of network events: “normal” network events (represented by circles) and “anomalous” network events (represented by squares). As described above, “normal” and “anomalous” are intended only as labels to differentiate two classes of network events. As described above, in the context of a payment processing network, a normal network event could comprise, e.g., a domestic or “in border” credit card transaction, taking place within a particular country or geographic region where a credit card or credential was issued. By contrast, an anomalous network event could comprise an international or “cross border” credit card transaction, taking place outside the particular country or geographic region where the credit card or credential was issued. For example, if a credit card was issued in Peru, a normal network event could comprise a credit card transaction that took place within Peru, whereas an anomalous network event could comprise a credit card transaction that took place outside of Peru. As such, in some embodiments, a normal training network event data record can comprise a network event data record corresponding to an access request made by a training user (e.g., a user associated with the normal training network event data record) from within a specified geographic region (optionally from a training user device corresponding to the training user), and an anomalous training network event data record can correspond to an access request made by the training user from outside the specified geographic region.

As another example, in the context of a cloud computing network, a normal network event could comprise, e.g., a communication between a worker node and an orchestrator computer, in which the worker node transmits the result of a computation to the orchestrator computer and requests a new computation task. By contrast, an anomalous network event could comprise, e.g., a failure by a worker node to complete a computational task. Network event data records can be “training network event data records,” network event data records used to derive training data that can be used to train a machine learning model.

FIG. 2 further illustrates the concept of time gaps between network events. For example, time gap 208 corresponds to the time difference between a network event that took place on February 1^{st}, and a subsequent network event that also took place on February 1^{st}. Time gap 210 corresponds to the time difference between a network event (216) that took place on February 2^{nd}, and the subsequent network event, which took place three days later on February 5^{th}. Notably, time gaps do not need to be between subsequent network events. Time gap 212 corresponds to the time difference between the first network event that took place on February 1^{st} and the last network event that took place on February 1^{st}. In general, a time gap (such as a “training time gap” used to train a machine learning model or an “input time gap, which can be classified by a trained machine learning model) can be defined based on a difference between a first timestamp or first time value associated with a first network event data record (e.g., a first input network event data record or a first training network event data record) and a second timestamp or second time value associated with a second network event data record (e.g., a second input network event data record or a second training network event data record).

In some cases, time gaps between normal network events (with no intervening anomalous network events) can be referred to as “normal” time gaps. For example, in a cloud computing network, a particular worker node may not have worked on any computing tasks during time gap 210 because of an unusually low computing demand volume. As another example, in a payment processing network, a particular cardholder may not have made any purchases during time gap 210 because they had no need to, e.g., they had completed all their necessary purchases on February 2^{nd}.

Time gaps may also comprise gaps between sequential network events of one class (e.g., normal network events) regardless of any number of intervening network events of another class (e.g., anomalous network events). For example, time gap 214 is between the last normal network event on February 6^{th}, and the next normal network event on February 10^{th}, with six intervening anomalous network events. Such time gaps may be referred to as anomalous time gaps, and may have meaning or significance based on both the context (e.g., cloud computing networks, payment processing networks, navigational networks, etc.) and the definitions of both normal and anomalous network events within those contexts. For example, if a normal network event is defined as domestic credit card transaction, and an abnormal network event is defined as an international credit card transaction, then time gap 214 could indicate a period of international travel by a credit card holder. As another example, if a normal network event is defined as a combination of a successful computation by a worker node and a request for additional tasks, and an abnormal network event is defined as an unsuccessful computation by a worker node, then time gap 214 could indicate a period of malfunction by a worker node.

The network events before and after a time gap can be indicative of the nature of the time gap, e.g., whether that time gap comprises a normal time gap or an anomalous time gap. Conceivably, network events 218 before time gap 214 and network events 220 after time gap 214 could indicate (for example) whether a cardholder travelled during that time period, or whether a worker node experienced a period of malfunction or downtime. As such, data contained in network event data records, or features derived from that data (described in detail further below) can be used to predict, estimate, or classify time gaps such as time gap 214 as normal or anomalous.

Timeline 202 of FIG. 2 shows both normal network events and anomalous network events. As such, it is possible to deduce, by observation of FIG. 2 alone (and without any data from network events before the time gap and network events after the time gap) that time gap 210 is normal (because it contains no intervening anomalous network events) and that time gap 214 is anomalous (because it contains intervening anomalous network events). However, in many practical contexts, data may not be available for anomalous network events. As an example, in the context of a cloud computing network, a worker node may not report its crashes, as it may be offline or in the process of rebooting. Likewise, in the context of a payment processing network, a cardholder may use a different card (or cash) when travelling abroad. As such, there may not be anomalous network event data records that can be used to qualify a time gap as normal or anomalous.

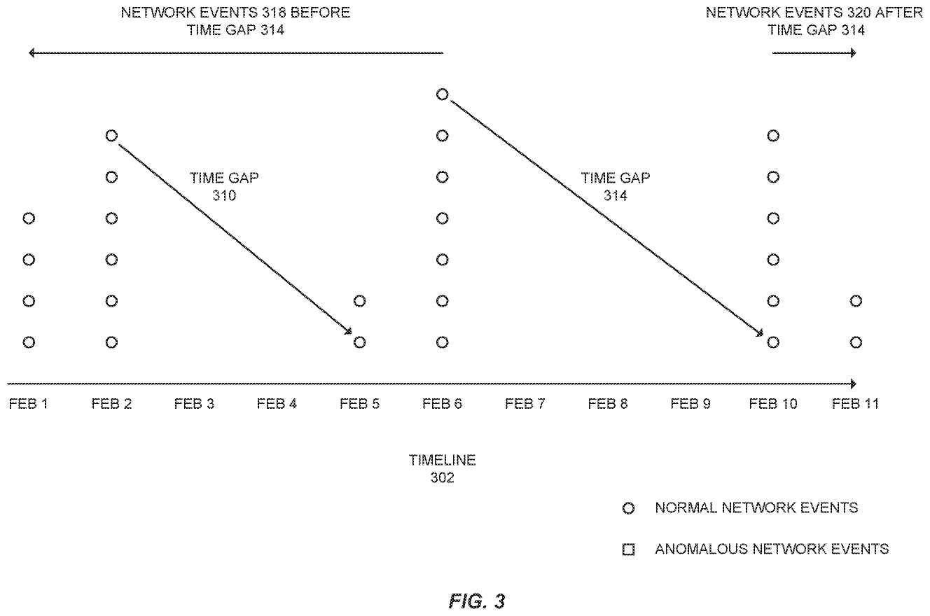

FIG. 3 shows a timeline 302 of normal network events without anomalous network events, which illustrates the difficulty in determining whether time gaps such as time gaps 310 and 314 are normal or anomalous. In such cases network event data corresponding to network events 318 occurring before time gap 314 and network event data corresponding to network events 320 occurring after time gap 314 can be used to determine whether time gap 314 is a normal time gap or an anomalous time gap. As described below, machine learning models can use this network event data or features derived from this network event data to perform this classification process.

### II. Machine Learning Overview

Generally, it is assumed that any potential practitioners of embodiments of the present disclosure are familiar with machine learning and are generally capable of implementing a variety of machine learning models for a variety of tasks. As such, machine learning models according to embodiments are not described in exhaustive detail. However, a broad overview of machine learning and machine learning classifier systems is provided in order to orient the reader.

A “classifier” typically refers to a machine learning model that produces classifications corresponding to input data. For example, in embodiments of the present disclosure, a classifier can produce classifications indicating whether a particular time gap is a normal time gap or an anomalous time gap, based on input data corresponding to network events that occurred both before and after that time gap. A classifier that produces one of two classifications is sometimes referred to as a “binary classifier.” Classifiers (and more generally, machine learning models) are often defined by sets of parameters, which generally control how the machine learning model classifies input data. As an example, a support vector machine (SVM) is a type of machine learning model that models input data as data points in a space. This space can be divided by a hyperplane. Input data points on one “side” of the hyperplane are classified as one class (e.g., normal), while data points on the other side of the hyperplane is classified as another class (e.g., anomalous). The parameters of the support vector machine can comprise the coefficients used to define the hyperplane. Changing these parameters changes the shape of the hyperplane, and thus changes which data points the SVM classifies as normal or anomalous. Other examples of classifiers include decision trees, random forests, and neural networks.

In some cases, the input data can comprise “data features” or more generally “features,” which may be derived from other data. As an example, network event data records, such as network event data record 102 from FIG. 1 can be used to derive data features. To continue the example, rather than using the “AMOUNT” value ($92.00) from network event data record 102, a machine learning model could use an input feature comprising the average amount or total amount spent over the last 10 network events (transactions), over the last three months, or over any other suitable amount of time. Likewise, instead of comprising a specific location contained in a network event data record (e.g., Portland OR, 97220 in network event data record 102), an input feature could comprise a categorical location such as “north west United States” that can be derived from that network event data record.

In broad terms, the process of training a machine learning model can involve determining the set of parameters that achieve the “best” performance, often based on the output of a loss or error function. A loss function typically relates the expected or ideal performance of a machine learning model to its actual performance. For example, if there is a training data set comprising input data paired with corresponding labels (indicating, e.g., whether that input data corresponds to normal data or anomalous data), then a loss function or error function can relate or compare the classifications or labels produced by the machine learning model to the known labels corresponding to the training data set. If the machine learning model produces labels that are identical to the labels associated with the training data, then the loss function may take on a small value (e.g., zero), while if the machine learning model produces labels that are totally inconsistent with the labels corresponding to the training data set, then the loss function may take on a larger value (e.g., one, a value greater than one, infinity, etc.).

In some cases, the training process can involve iteratively updating the model parameters during training rounds, batches, epochs, or other suitable divisions of the training process. In each round, a computer system can evaluate the current performance of the model for a particular set of parameters using the loss or error function. Then, the computer system can use metrics such as the gradient and techniques such as stochastic gradient descent to update the model parameters based on the loss or error function. In summary terms, the computer system can predict which change to the model parameters result in the fastest decrease in the loss function, then change the model parameters based on that prediction. This process can be repeated in subsequent training rounds, epochs, etc. The computer system can perform this iterative process until training is complete. In some cases, the training process involve a set number of training rounds or epochs. In other cases, training can proceed until the model “converges”, i.e., the model shows little to no further improvement in successive training rounds, or that the difference in the output of the error or loss function between successive training rounds approaches zero.

Once training has been completed, a trained classifier can be used to classified unlabeled input data based on the parameters determined during training. In the context of embodiments, data features corresponding to a time gap can be input into a trained classifier, which can then return a classification or label, e.g., “normal” or “anomalous.” Optionally, a classifier can return a value that corresponds to the classifier's confidence in its classification. A classification such as “normal 0.95” could indicate that the classifier classifies the time gap as normal with 95% confidence. Alternatively, numeric output values can indicate both the classifier's classification and it's confidence. For example, if the value 0 corresponds to a normal classification, and the value 1 corresponds to an anomalous classification, then an output classification such as 0.01 could indicate high (but not complete) confidence that a time gap is normal, while a classification such as 0.5 could indicate classification ambiguity between a normal time gap and an anomalous time gap.

### III. Systems

Having described concepts such as network event data models and machine learning, it may now be useful to describe some systems according to embodiments of the present disclosure. FIG. 4 shows an exemplary resource access control system (also referred to as a resource access control network) 402. The resource access control system 402 may be used to provide authorized users (such as user 404) access to resources (such as physical resources 414 or electronic resources 416) via authentication, while denying access to unauthorized users. The resource access control system 402 can be used to identify and deny fraudulent access requests based on parameters of those access requests, based on e.g., a set of access rules from an access rules database 432. In some embodiments, the resource access control system 402 can comprise a payment processing network.

The resource access control system 402 can additionally comprise a computer system 424 configured to perform methods according to embodiments. In general, the computer system 424 can train and use a machine learning model 426 to determine if gaps in network activity (e.g., by users, such as user 404) are normal or anomalous. Network event data records corresponding to network events (or alternatively, access requests) can be used to derive features that can be used by the machine learning model 426 to classify gaps in network activity in this way.

The devices, computers, and entities in resource access control system 402 can communicate with one another via one or more communication networks, such as communication network 430. Communication network 430 can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a wireless application protocol (WAP), I-mode, and/or the like); and/or the like. Messages between the computers and devices in resource access control system 402 may be transmitted using a communication protocol such as, but not limited to, File Transfer Protocol (FTP); Hypertext Transfer Protocol (HTTP); Secure Socket Layer (SSL), ISO (e.g., ISO 8583) and/or the like.

Messages (e.g., access requests to request access to network resources such as user accounts) sent between the computers and devices in resource access control system 402 may be transmitted in encrypted or unencrypted form. For example, an authorization request message or access request may be encrypted before being transmitted from access device 408 (or resource provider computer 410) to processing computer 420 (e.g., via transport computer 418). If messages are encrypted, the computers and devices in system 402 can use a public key infrastructure, perform a key exchange (e.g., a Diffie-Hellman key exchange), or use any other appropriate means to enable the computers and devices to encrypt and decrypt messages.

When communicating over a communication network such as the Internet, there is a reasonable probability that messages or other data sent between two computers or devices in the system 402 may be routed between an indeterminate number of intermediary computers or devices. For simplicity's sake, such intermediate computers are not included in FIG. 4. Further, in some embodiments, not all computers, devices, or entities in FIG. 4 may be necessary to complete methods according to embodiments. For example, the processing computer 420 and computer system 424 can comprise a single computer system, and the access device 408 could communicate directly with the combined computer system comprising the processing computer 420 and the computer system 424, rather than communicating via the resource provider computer 410, the transport computer 418, and processing computer 420.

The particular configuration of computers and devices in FIG. 4 was selected to illustrate some useful applications of embodiments of the present disclosure, particularly within the general context of resource provisioning. In such a context, a user 404 may request access to resources managed by a resource provider 412, including physical resources 414 and electronic resources 416. Although one resource provider 412 is shown, resource access control systems such as resource access control system 402 can comprise one or more resource providers (e.g., merchants) individually or collectively managing sets of resources (e.g., goods or services provided by those resource providers).

One example of a physical resource 414 is access to a secure or otherwise access-controlled location. An example of such a location is a government facility. In this example, the user device 406 could comprise a smart ID card, the access device 408 could comprise a terminal that interfaces with the smart ID card, the resource provider computer 410 could comprise a computer system operated by a resource provider 412 (e.g., a guard who is guarding the entrance to the access-controlled location), and the transport computer 418, processing computer 420, authorization computer 422 and access rules database 432 could comprise part of a computer network for the government facility. In this example, the resource access control system 402 can be used to authenticate the user 404, and thereby verify that the user 404 has access to the government facility. For example, the processing computer 420 can use access rules defined by access rules database 432 to determine if the user 404 is authorized to access the government facility. If the user is successfully authenticated, the resource provider 412 (i.e., the guard) can grant the user 404 access, e.g., by unlocking a door. If the user 404 is not successfully authenticated, the resource provider 410 can take any appropriate steps, e.g., asking the user 404 to leave, attempting to authenticate the user 404 again, etc.

Another example of a resource (either physical or electronic) is a good or service provided by a merchant resource provider 412. In such a case, the system 402 can be used to authenticate the user 404 in order to verify that the user 404 is authorized to perform a transaction with the merchant in order to acquire the resource. In this example, the user device 406 can comprise a credit card, the access device 408 can comprise a point of sale terminal, the resource provider computer 410 could comprise a merchant computer connected to the access device 408, and the transport computer 418 can comprise an acquirer computer associated with an acquiring entity 434 (e.g., an acquiring bank) that manages an account (e.g., a bank account) on behalf of the merchant resource provider 412. Further, the processing computer 420 can comprise a computer that is part of a payment processing network (e.g., the Visa payment processing network), and the authorization computer 422 can comprise an issuer computer associated with an issuing entity 436 (e.g., an issuing bank) that manages an account (e.g., a bank account) on behalf of the user 404, and which may have issued the user device 406 (e.g., a credit card) to the user 404. In this case, the resource access control system 402 can comprise a “four party network” (sometimes referred to as a “four party scheme”), a system used to enact credit card transactions. Alternatively, an account (e.g., a credit account or a checking account) itself could comprise or be considered a resource, and the user can interface their user device 406 (credit card) with the access device 408 (such as an ATM) in order to gain access to their account, for example, in order to make a withdrawal.

A resource provider (such as resource provider 412) does not necessarily need to be a human or organization. As an example, a smart building can function as a resource provider, e.g., by opening a mechanized lock to grant the user 404 access to an access controlled location (an example of a physical resource 414). As another example, a server computer resource provider 412 associated with a streaming service can provide a user 404 access to streamed videos and movies (an example of an electronic resource 416) without the intervention of a human resource provider. Likewise, an online retailer may perform transactions with user 404 without any direct participation by a human employee.

The user device 406 and access device 408 may each include user input interfaces, such as keypads, keyboards, fingerprint readers, retina scanners, other biometric readers, magnetic stripe readers, chip card readers, radio frequency identification reader, or wireless or contactless communication interfaces, as examples. The user 404 may input authentication information (such as a credential, such as a payment account number) into the access device 408 or the user device 406 in order to access either physical resources 414 or electronic resources 416. Authentication information may include, for example, data samples corresponding to a username, an access number, a token, a password, a personal identification number, a signature, a digital certificate, an email address, a phone number, a physical address, and a network address. These data elements may be labelled as corresponding to particular fields, e.g., a particular data element may be labelled as an email address.

As described above, the computer system 424 can be used to determine if time gaps (e.g., periods of time between two normal network events) are normal or anomalous. In this context, an anomalous network event could correspond to international travel by the user 404, such as a period of time when the user travels outside of a particular geographic region (e.g., a country) and does not use their user device 406 to perform credit card transactions during that time period, although such the user 404 may use a different user device (not pictured), e.g., corresponding to a competing resource access control system during their travels. Identifying such time gaps may be useful to issuing entities (such as issuing entity 436), e.g., issuing banks, who may want to identify users who aren't using their credit cards while travelling abroad, e.g., to target those users with promotional campaigns in order to acquire greater market share. The computer system 424 can comprise one or more processors and a non-transitory computer readable coupled to the one or more processors. The non-transitory computer readable medium can comprise code or instructions, executable by the processors for performing some methods according to embodiments. Additionally, the non-transitory computer readable medium can be used to store a machine learning model 426 and maintain a network event database (also referred to as a historical access request database) 428.

During a training process (described in more detail below), the computer system 424 can generate a plurality of training data samples that can be used to train the machine learning model 426 to identify if time gaps are normal or anomalous. The computer system 424 can retrieve a plurality of historical access requests from a network event database (also referred to as a historical access request database) 428. In the context of a payment processing network, the plurality of historical access requests can correspond to a plurality of historical authorization requests, which can request authorization for a plurality of transactions (e.g., credit card transactions) between a plurality of requestors (e.g., cardholders, such as user 404) and one or more merchant resource providers. Afterwards, the computer system 424 can use the trained machine learning model 426 to classify gaps in network activity (determined, e.g., from network event data records or access requests from the historical access request database) as normal or anomalous.

In the context of credit card payments, during the course of a network event, the user device 406 (e.g., a credit card) may include or store credit card data (e.g., data included in a normal credit card transaction, such as a credential such as a payment account number (PAN)) in a transmission to the access device 408 (e.g., a point of sale terminal) during an interfacing. Examples of interfacing can include inserting the user device 406 into the access device 408, sliding the user device 406 through a magnetic strip reader located on the access device 408, tapping the user device 406 against the access device 408 to activate near field communication, etc. Alternatively, the user 404 can manually enter any relevant credit card data (such as the PAN, a card verification value (CVV), an expiration date, etc.) into the access device 408. The access device 408 can include this credit card data in an authorization request message, which can be routed through the system 402 to the processing computer 420 (e.g., a server computer associated with a payment processing network such as Visa). The processing computer 420 can analyze the authorization request message and forward it to an authorization computer 422 (e.g., a computer system associated with an issuing bank that issued the user device 406 to the user 404) for authorization. Optionally, the processing computer 420 can use access rules retrieved from access rules database 432 to determine whether the authorization request message is a legitimate request from the user 404 or a fraudulent request (e.g., made by a fraudster using a stolen credit card).

After receiving the authorization request message, the authorization computer 422 can analyze the authorization request message and determine whether or not to authorize the credit card transaction, such analysis can include risk evaluation, and can involve evaluating a transaction amount, the time of the transaction, the recent frequency of transactions, or any other data that may be indicative of legitimate or fraudulent use of a credential or user device. Responsive to the authorization request message, the authorization computer 422 can generate an authorization response message, indicating whether the transaction has been approved or denied. This authorization response message can be routed back through the system 402, and can be displayed on the access device 408, e.g., indicating to the user 404 and the merchant resource provider 412 whether the transaction has been approved or denied.

During the course of this network event (credit card transaction) the processing computer 420 can communicate with the computer system 424, enabling the computer system 424 to store information related to this network event in a network event data record, which can itself be stored in the network event database 428 (also referred to as a historical access request database”, and can later be used to derive training data used to train the machine learning model 426, or which later can be classified using the machine learning model 426, as described above.

### IV. Methods

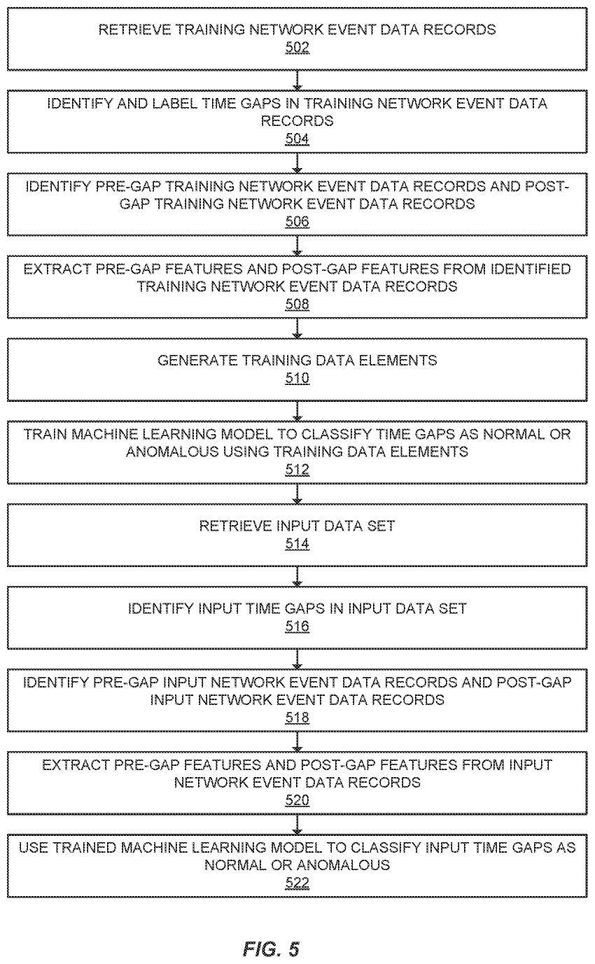

Having described both systems according to embodiments and some background concepts, it may now be helpful to describe some methods according to embodiments. In general, methods according to embodiments can involve the use of a machine learning model to classify gaps in network activity as normal or anomalous. As such, these methods can be broadly divided into training methods, which can be used by a computer system train a machine learning model, and classification methods, which can involve the computer system using the machine learning model to classify time gaps as normal or anomalous. These training and classification methods are described in more detail in the following sections and with reference to FIG. 5.

### V. Training

The process of training a machine learning model generally corresponds to steps 502-512 in FIG. 5. Embodiments of the present disclosure can make use of a variety of machine learning models to classify network activity gaps as normal or anomalous, such as support vector machines, decision trees, gradient boosted decision trees (such as XGBoost), random forests, neural networks, linear regression, logistic regression, or any other appropriate machine learning model. In some cases, an entity such as a computer system or a data scientist may have already prepared a plurality of training data samples that can be used to train a machine learning model to classify time gaps as normal or anomalous. In such circumstances, a computer system can retrieve this plurality of training data samples and use the plurality of training data samples to train the machine learning model, in accordance with any appropriate training method corresponding to that machine learning model.

However, in some cases pre-processed training data may not be available to the computer system. As such, the computer system can perform data processing operations in order to generate a set of training data that can be used to train a machine learning model. These operations may include data record retrieval (e.g., involving the retrieval of network event data records that can be used to generate the set of training data), time gap identification and labelling, and feature extraction. These operations are described in more detail in the following sections. In general, during steps 502-510, the computer system can generate a plurality of training data samples, which can each provide (e.g., identify or comprise) (1) a training time gap between two training network events, (2) a training label indicating whether the training time gap comprises a normal time gap or an anomalous time gap, (3) a set of pre-gap features corresponding to training network events that took place before the training time gap, and (4) a set of post-gap features corresponding to training network events that took place after the training time gap. Afterwards, at step 512, the computer system can then train a machine learning mode using that plurality of training data samples.

In some embodiments, each training data sample of the plurality of training data samples can corresponding to a user of a user device (e.g., a cardholder of a credit card). In such a case, the corresponding user may be referred to as a “training user” (or “corresponding training user”) and the corresponding device may be referred to as a “training user device” (or “corresponding training user device”), in order to differentiate from users and devices corresponding to network events or access requests classified by the trained machine learning model (e.g., as described further below).

In some embodiments, the plurality of training data samples can comprise one or more normal training data samples and one or more anomalous training data samples, and can be derived from a plurality of training network event data records, which can be used to train the machine learning model to classify input data as normal or anomalous. Further, each training data sample of the plurality of training data samples can correspond to a corresponding training user and a corresponding training network resource (e.g., a resource that the user requests to access). In some embodiments, each corresponding training network can comprise a corresponding training user account (e.g., a corresponding training user credit card account). The plurality of training data samples can be derived from a plurality of training network event data records, which can comprise one or more normal training network event data records (e.g., corresponding to normal network events) and one or more anomalous training network event data records (e.g., corresponding to anomalous network events). In order to derive the training data samples, a computer system can retrieve the plurality of training network event data records, using e.g., methods as described in the following section.

A. Data Record Retrieval

At step 502, the computer system can retrieve a plurality of training network event data records (corresponding to a plurality of training network events) to use to derive or generate the plurality of training data samples. In the context of a resource access control system, these training network events can comprise or correspond to a plurality of historical access requests for a set of resources managed by a network (e.g., a four-party payment processing network, as depicted in FIG. 4). In some embodiments, each of these historical access requests can include historical access data identifying a corresponding resource (e.g., a good or service, or a user account associated with a user, such as a user credit card account) of a set of resources, and can further include requestor information (e.g., a requestor credential associated with a corresponding requestor, or a requestor identifier associated with the requestor). The computer system can retrieve the plurality of training network event data records (or historical access requests) from a network event database (or historical access request database).

In binary classification, in which something (e.g., a time gap) is labeled as one of two classes, typically training data contains examples from both classes, in order to enable a machine learning model to identify features correlated with each class. In the context of labelling time gaps as normal or anomalous, the computer system can identify training network event data records corresponding to both normal time gaps and anomalous time gaps in order to derive the plurality of training data samples. Identifying relevant sets of network event data records can depend, in large part on what is considered a normal time gap and an anomalous time gap for a given type of network and a given application. As one example, a normal time gap can be defined as a gap between two successive normal network events with no intervening anomalous network events, and an anomalous time gap can be defined as a gap between two successive normal network events with intervening anomalous network events. In the context of international credit card transactions, a normal training network event data record can correspond to an access request made within a specified geographic region (e.g., the geographic region where a credit card was issued), while an anomalous training network event data record can correspond to access requests made from devices outside the specified geographic region. In order to produce training data representative of both normal time gaps and anomalous time gaps, the computer system can identify a plurality of training network event data records corresponding to both normal network events and anomalous network events.

In the context of payment processing networks, these relevant sets of network event data records can correspond to historical access requests by known travelers, cardholders who are known to use the same credit card for both domestic credit card transactions and international credit card transactions. The computer system may maintain or have access to a network event database (also referred to as a historical access request database). If such sets of network event data records are already labelled (e.g., indicating if they correspond to known travelers), indexed, or sorted, the computer system can identify and retrieve these relevant sets of network event data records based on this labelling, indexing, or sorting.

However, if the network event data records are not indexed or labelled in this way, the computer system may parse through sets of network event data records in order to identify the plurality of training network event data records used to generate training data. There are a large variety of methods or techniques that can be used for this purpose. As one exemplary method, the computer system can iterate through sets of network event data records in the database and check each network event data record in sequence, in order to determine if those sets of network event data records contain both network event data records corresponding to normal network events and anomalous network events. In the context of a payment processing network, each set of network event data records could correspond to the same cardholder. The computer system can use data stored in each network event data record to identify if a set of network event data records comprises network event data records corresponding to both normal network events and anomalous network events. For example, the computer system can use a “LOCATION” data field (as depicted in FIG. 1) contained in the network event data records. If the computer system determines that at least two network event data records (within the same set of network event data records) correspond to locations in different countries or geographic locations, then the computer system can determine that the set of network event data records contains network event data records corresponding to both normal network events and anomalous network events.

The computer system can repeat this process (or another appropriate process for determining if a set of network event data records contains network event data records corresponding to both normal network events and anomalous network events) for any number of sets of network event data records until the computer system has accumulated a sufficient quantity of sets of network event data records to derive the training data. Afterwards, the computer system can then perform a gap identification process in order to identify and label normal time gaps and anomalous time gaps among the identified sets of network event data records, as described in the section below.

B. Gap Identification

At step 504, the computer system can identify a plurality of training time gaps that can be used to train the machine learning model. Each training time gap can be between a respective first training network event corresponding to a first network event data record of the plurality of training network event data records (identified in step 502) and a respective second training network event data record of the plurality of training network event data records. In some contexts, the first network data event record can correspond to a first network resource or a first set of network resources, and the second network event data record could correspond to a second resource or a second set of network resources. For example, in the context of a payment processing network, the first network event data record could correspond to a first set of goods and services (network resources) purchased by a cardholder using their credit card, while the second network event data record could correspond to a second set of goods and services purchased by the cardholder using their credit card.

For each identified training time gap, the computer system can determine a label (e.g., normal or anomalous) corresponding to that training time gap. In the context of detecting travel activity by users (e.g., cardholders of credit cards), a normal training label provided by (e.g., corresponding to) a corresponding training data sample can indicate that a corresponding training time gap comprises a time period during which no historical access requests (e.g., requests for resources such as goods or services via e.g., a payment processing network) were made by a corresponding training user (e.g., a cardholder of a corresponding training user device, e.g., a credit card, payment enabled smartphone, etc.) of a corresponding training user account (e.g., a credit card account associated with that user) from outside a specified geographic region (e.g., the region where the user device was issued to the user, the user's country of residence, etc.). Likewise, an anomalous training label provided by a corresponding training data sample can indicate that a corresponding training time gap comprises a time period during which one or more historical access requests were made by a corresponding training user (e.g., of a corresponding training user device) of a corresponding training user account from outside the specified geographic region.

If necessary, prior to identifying such time gaps, the computer system can sort each set of network event data records of the identified sets of network event data records chronologically based on timestamps or time values associated with each network event data record. This chronological sorting can enable the computer system to identify time gaps between sequential network event data records according to the chronological sorting. The computer system can use any appropriate method to identify time gaps in network event data, one exemplary method is described below.

For each identified and chronologically sorted set of training network event data records in the plurality of training network event data records, the computer system can iterate through that set of training network event data records in order to identify normal and anomalous time gaps. There are a variety of ways this can be accomplished and one exemplary method is as follows. The computer system can start by identifying the first normal training network event data record in that set of training network event data records. The computer system can begin at the first Training network event data record and evaluate whether it comprises a normal training network event data record or an anomalous training network event data record. As an example, in the context of a payment processing network in which normal network events comprise domestic credit card transactions and anomalous network events comprise international credit card transaction transactions, then the computer system can evaluate whether the training network event data record under evaluation corresponds to a normal training network event or an anomalous training network event by evaluating a “country” or “location” data field associated with that training network event data record. After evaluating the first training network event data record, the computer system can advance to the next training network event data record, and so on, until it identifies the first normal training network event data record in the chronologically sorted set of network event data records.

After the computer system has identified the first normal training network event data record in the chronologically sorted set of network event data records, the computer system can then identify normal and anomalous time gaps within that set. Again, there are a variety of methods in which this can be accomplished. As one example, the computer system can identify a first normal training network event data record and a second normal training network event data record, corresponding to the start and end of a time gap respectively. The computer system can then determine if there are one or more intervening anomalous training network event data records between the first normal training network event data record and the second normal training network event data record. If there are one or more intervening anomalous training network event data records between the first normal training network event data record and the second normal training network event data record, then the computer system can identify an anomalous training time gap, and can generate or determine an anomalous training label corresponding to that anomalous training time gap. If there are no anomalous training network event data records between the first normal training network event data record and the second normal training network event data record, then the computer system can identify a normal training time gap, and can generate or determine a normal training label corresponding to that normal training time gap.

In the context of payment processing networks and domestic and international credit card transactions, a normal training label can indicate that a corresponding training time gap comprises a time period during which no historical access requests were made by a corresponding training user of a corresponding training account from a device or devices (e.g., credit cards, payment enabled smartphones) outside a specified geographic region (e.g., the country where a credit card was issued), while an anomalous training label can indicate that a corresponding training time gap comprises a time period during which one or more historical access requests were made by a corresponding training user of a corresponding training account from a device or devices outside the specified geographic region.

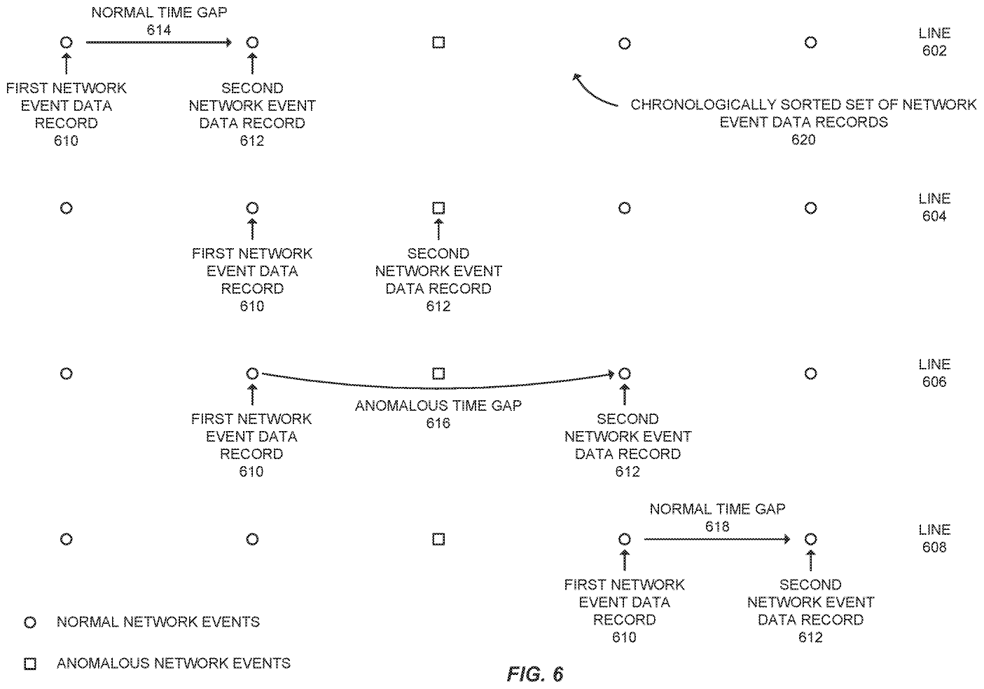

An exemplary process for identifying and labeling normal and anomalous training time gaps is described in more detail with reference to FIG. 6, which shows a chronically sorted set of five training network event data records corresponding to both normal network events and to anomalous network events. As described above, the computer system can identify normal and anomalous time gaps by comparing a first training network event data record (610 in FIG. 6) and a second training network event data record (612 in FIG. 6) in order to determine the length of a training time gap and whether that time gap is normal or anomalous. Initially, the first network event data record 610 can comprise the first normal network event data record, and the second network event data record 612 can comprise the network event data record immediately following the first normal network event data record 610 based on the chronological ordering. This situation is shown in line 602 of FIG. 6.

The computer system can evaluate whether the second network event data record 612 corresponds to a normal network event or an anomalous network event, e.g., based on a data field (such as a location or country data field) in the second network event data record 612 as described above. If the second network event data record 612 corresponds to a normal network event, than the computer system can identify a sequence of two normal training network events with no intervening anomalous network events, and therefore can identify a normal time gap 614 between the first network event data record 610 and the second network event data record 612. The computer system can include this normal time gap 614 in the plurality of training time gaps, which can later be used to train a machine learning model to classify input time gaps as normal or anomalous. The computer system can record the normal time gap 614, for example, as a pair of network event data records comprising the first network event data record 610 and the second network event data record 612. The computer system can also determine the length of this time gap by comparing any timestamps or time values associated with each network event data record, e.g., by subtracting a time value associated with the second network event data record 612 from a time value associated with the first network event data record 610. The length of the time gap can also be recorded in association with the recorded time gap. Likewise, the computer system can include a normal training label (indicating that the normal time gap 614 is normal) in a plurality of training labels.

In some cases, time gaps that are less than a threshold length of time may not be relevant, and therefore may not be useful as training data. For example, in the context of domestic and international credit card transactions, cardholders are probably not engaging in international travel during, e.g., one hour gaps between domestic credit card transactions. Generating training data corresponding to small time gaps may not be necessary. As such, the computer system can optionally evaluate whether the duration or length of a time gap (e.g., normal time gap 614) is greater than or equal to a threshold length. If so, the computer system can record that time gap as described above. Otherwise, the computer system may elect not to include that time gap in the plurality of time gaps. Exemplary threshold lengths include between one and fourteen days, although such thresholds can generally be set at the discretion of practitioners of embodiments, and therefore longer or shorter thresholds are also possible.

After a normal time gap (e.g., normal time gap 614) has been detected, the computer system can select a new first network event data record 610 and a new second network event data record 612, e.g., by advancing past the detected time gap and evaluating the training network event data records corresponding to training network events that occurred after that training time gap. This situation is shown in line 604 of FIG. 6. The computer system can then evaluate whether the second training network event data record 612 corresponds to a normal training network event or an anomalous training network event. In this case, the second training network event data record 612 corresponds to an anomalous training network event. If an anomalous training time gap comprises a time gap between two normal training network events with intervening anomalous training network events, the anomalous second training network event data record 612 can indicate the presence of an anomalous training time gap. However, the computer system may not be able to determine the length of this anomalous training time gap without evaluating subsequent training network event data records.

In order to determine the length of this anomalous time gap, the computer system may then select a new second network event data record 612, subsequent to the old second network event data record, as shown in line 606. The computer system can evaluate whether this new second network event data record 612 comprises a normal network event data record or an anomalous network event data record. In this case, the second network event data record 612 comprises a normal network event data record, which can indicate the end of the anomalous time gap 616. The computer system can include the anomalous time gap 616 in the plurality of training time gaps, and can optionally determine and record the length of anomalous time gap 616. Likewise, the computer system can include a normal training label (indicating that the anomalous time gap 616 is anomalous) in the plurality of training labels.

Once again, the computer system can select a new first training network event data record 610 and a new second training network event data record 612, by advancing past the detected anomalous training time gap 616. This situation is shown in line 608 of FIG. 6. The computer system can determine whether the second training network event data record 612 comprises a normal training network event data record or an anomalous training network event data record. In this case, the second training network event data record 612 comprises a normal training network event data record, indicating that a normal training time gap 618 exists between the first training network event data record 610 and the second training network event data record 612. The computer system can include the normal training time gap and its length in in the plurality of training time gaps, and can include an anomalous training label in the plurality of training labels. Optionally, the computer system can verify that the length of the time gap is greater than or equal to a threshold length, e.g., as described above.

Upon completing this process, the computer system can have added both normal training time gaps and anomalous training time gaps to the plurality of training time gaps, and can additionally have added both normal training labels and anomalous training labels to the plurality of training labels. This process can be repeated for any number of sets of chronologically sorted network event data, until an appropriate, sufficient, or desirable quantity of training examples of normal and anomalous time gaps has been acquired by the computer system. Afterwards, as described below, the computer system can perform a feature extraction process in order to extract data features from network event data records that a machine learning model can use to learn to classify time gaps as normal or anomalous.

C. Identifying Pre-Gap and Post-Gap Records

At step 506, the computer system can identify pre-gap training network event data records and post-gap training network event data records, which can be used to extract pre-gap features and post-gap features that can be used to train the machine learning model. Expressed in other words, the computer system can generate a training set of historical access requests that occur before and after each training time period of the plurality of training time periods. The computer system can identify these pre-gap training network event data records and post-gap training network event data records for each training time gap of the plurality of training time gaps. The one or more pre-gap training network event data records can correspond to training network events that occurred before a respective training time gap, and the one or more post-gap training network event data records can correspond to training network events that occurred after the training time gap. The computer system can identify the one or more pre-gap training network event data records based on a chronological ordering of the plurality of training network event data records. The one or more pre-gap training network event data records can comprise training network event data records corresponding to training network events that occurred before a first respective training network event. Likewise, the computer system can identify the one or more post-gap training network event data records based on a chronological ordering of the plurality of training network event data records. The one or more post-gap training network event data records can comprise training network event data records corresponding to training network events that occurred after a second respective training network event.

In some embodiments, the one or more pre-gap training network event data records can comprise a predetermined pre-gap training number of pre-gap network data event records or can be defined by a pre-gap training time range. In some embodiments, the pre-gap training time range can be less than or equal to a year (e.g., 6 months). Likewise, the one or more post-gap training network event data records can comprise a predetermined post-gap training number of post-gap training network event data records or can be defined by a post-gap training time range. In some embodiments, the post-gap training time range can be less than or equal to a year (e.g., two weeks).

As described above, the computer system can use training network event data records both before and after a training time gap to derive or extract features that can be used for training. The computer system can identify these relevant training network event data records based on the plurality of identified training time gaps. There are a variety of ways in which this could be accomplished. For example, the computer system could iterate through each identified training time gap and identify a training network event data record corresponding to the start of that time gap (e.g., a respective first training network event data record) and a training network event data record corresponding to the end of that time gap (e.g., a respective second training network event data record). The computer system can then identify (e.g., from a particular set of training network event data records corresponding to that time gap) one or more training network event data records corresponding to network events before the time gap, and one or more training network event data records corresponding to network events occurring after that time gap. In some cases, the computer system may identify a predefined number of training network event data records occurring before and after the training time gap, e.g., 60 training network event data records before the time gap and 120 training network event data records after the training time gap (or any other suitable numbers). In other cases, the computer system may identify a number of training network event data records before and after the training time gap corresponding to predefined time periods or ranges. For example, the computer system could identify training network event data records corresponding to a six month period leading up to the training time gap and training network event data records corresponding to a two week period after the time gap (or any other suitable lengths of time). The computer system can use timestamps or time values associated with the training network event data records to identify relevant training network event data records in this manner.

D. Feature Extraction

At step 508, the computer system can extract sets of features derived from any access data of the training set of historical access requests determined in the previous steps of FIG. 5. Expressed in other words, the computer system can extract a set of pre-gap features from one or more pre-gap training network event data records (identified, e.g., at step 506) and can extract a set of post-gap features from one or more post-gap training network event data records. To do so, the computer system can perform a feature extraction process for each identified time gap (identified, e.g., at step 504). These pre-gap features, post-gap features, time gaps, and time gap labels can collectively comprise a plurality of training data samples that can later be used to train a machine learning model to classify time gaps as normal or anomalous.

Such feature extraction processes can depend on the types of networks (e.g., cloud computing vs payment processing) and the definition of normal and anomalous network events and time gaps in such networks. Useful features in one context may not be applicable in other contexts. For example, in a cloud computing network, a useful feature may comprise the average amount of time needed by a worker node to complete a computing task over a two week period. In the context of a payment processing network, there are probably no worker nodes or computing tasks performed by those worker nodes, and such a feature may not be meaningful for determining, e.g., whether a credit card holder travelled out of the country during a time gap.

As such, it is generally impossible to provide an exhaustive description of relevant features and feature extraction processes in all contexts. Instead, feature extraction is described at a relatively high level of detail, and some exemplary features are provided for a particular context, i.e., classifying time gaps in payment processing network events as normal or anomalous. As defined above, a feature generally refers to an individual measurable property or characteristic of a phenomenon. “feature vectors,” or ordered lists of features, are sometimes used as the inputs to machine learning models, and can be used by the models to classify something (e.g., a time gap) related to those features. “Feature extraction” or “feature construction” generally involves the determination of useful features from data (e.g., network event data records) or from other features. For example, if a network event data record corresponding to a payment processing network has an “amount” data field (e.g., corresponding to the amount spent on a particular transactional network event), then the computer system could use the amount data fields from multiple network event data records to determine the average amount spent over the last 6 months, the total amount spent over the last 6 months, etc. This average and/or total amount could then be used as a feature by the machine learning model.

As stated above, features can be extracted from network event data records corresponding to network events that took place before an identified time gap and network events that took place after the identified time gap. Such network event data records can contain data that can be used to determine whether the time gap is normal or anomalous. In the context of a payment processing network, if an anomalous time gap is defined as a period of time during which a cardholder travelled abroad, the user's purchases before and after that period of travel may provide some indication that the cardholder travelled abroad during that time period. For example, if a user used their credit card to pay for airline tickets or a taxi service before the time gap, that may be an indication that the user travelled during that time gap. As another example, in the context of a cloud computing network, if an anomalous time gap is defined as a period of time during which a worker node has crashed and is not performing or reporting the results computation tasks, the worker node's performance on computing tasks before and after the time gap may provide some indication that the worker node crashed during that time period. For example, if the worker node's performance (measured in computing task completion rates) was getting worse prior to the time period in question, it may indicate that the worker node was in the process of a slow hardware failure, and thus may have experienced a crash during the time period.

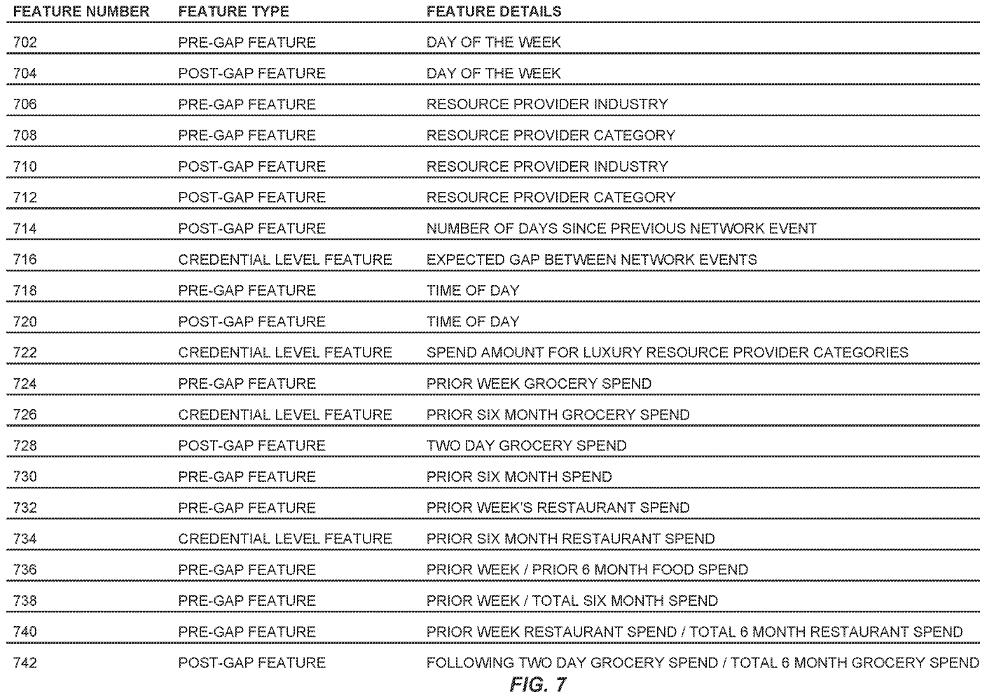

Some exemplary features corresponding to time gap classification in a payment processing network are shown in FIG. 7 and summarized in broad terms below. These features are characterized as “pre-gap features” (e.g., derived from network event data records corresponding to network events that took place before a time gap), “post-gap features” (e.g., derived from network event data records corresponding to network events that took place after a time gap), and “credential level features.” In the context of a payment processing network, a credential (or requestor credential) may refer to a credit card number or a payment account number (PAN). A credential level feature can therefore correspond to an account or cardholder as a whole or based on some long term criteria, rather than based on pre-gap or post-gap network event data records.

Feature 702 can comprise a pre-gap day of the week feature corresponding to a pre-gap network event data record. The day of the week corresponding to a cardholder's last network event (e.g., credit card purchase) prior to a time gap may provide insight as to whether that time gap is anomalous (e.g., whether the cardholder travelled during that time gap). In general, travel activities such as airline flights are most common on Fridays and least common on Tuesdays and Wednesdays, so such days may indicate whether a cardholder engaged in travel. Likewise, feature 704 can comprise a post-gap day of the week feature corresponding to a post-gap network event data record, e.g., corresponding to the day of the week of the first credit card transaction following the time gap. Such features can be derived from timestamps or time values contained in network event data records both before and after an identified time gap.

Feature 706 can comprise a pre-gap industry identifier corresponding to a resource provider (e.g., a merchant) associated with a pre-gap network event data record. Cardholders who are travelling may perform credit card transactions with merchants in particular industries (e.g., the transportation industry) prior to travelling. As such, the resource provider industry may be useful for classifying a time gap as normal or anomalous. Likewise, feature 708 can comprise a pre-gap category identifier corresponding to a resource provider associated with a pre-gap network event data record, such as a merchant category, denoted by a merchant category code. An example of a merchant category code is “4121,” corresponding to taxi cab or limousine services. Cardholders who are travelling may perform transactions within certain categories (e.g., taxi services) at higher frequency than cardholders who are not travelling. As such, a resource provider category may be useful for classifying time gaps as normal or anomalous. Resource provider industry and category features can be derived, e.g., from industry or category data values in network event data records.

Features 710 can comprise a post-gap industry identifier corresponding to a resource provider associated with a post-gap network event data record. Likewise feature 712 can comprise a post-gap category identifier corresponding to a resource provider associated with a post-gap network event data record. Such features can be useful for classifying time gaps as normal or anomalous, and can be derived from industry or category data values in network event data records. A cardholder who has travelled may be more likely to use their credit card to pay for taxi service from an airport, or may be more likely to perform a credit card transaction at a grocery store (e.g., in order to restock on food after their travels), and therefore the category or industry of such credit card transactions may indicate whether the cardholder has travelled during a time gap.

Feature 714 can comprise a post-gap feature corresponding to the number of days since a previous network event, which may be equivalent to the length of the network event. In general, a long period of time between network events may be indicative of a lengthy period of international travel, while a short period of time may be indicative of no international travel. As such, this feature may be useful for classifying time gaps as normal or anomalous. Likewise, feature 716 can comprise the expected or average gap between successive network events given a cardholder's historical data. Such a feature may provide useful context as to what comprises a normal length of time between credit card transactions by a particular cardholder. Features like 716 can be derived by averaging recorded gap durations, or alternatively by averaging the difference between successive timestamps or time values contained in network event data records.

Features 718 can comprise a pre-gap time of day corresponding to a pre-gap network event data record. Likewise, feature 720 can comprise a post-gap time of day corresponding to a post-gap network event data record. Such features may correspond to the time of day of the last network event before a time gap and the time of day of the first network event after a time gap. Such features may be derived from timestamps or time values associated with network event data records prior to and after a detected time gap, and may be useful for determining whether that time gap was normal or anomalous.

Feature 722 can correspond to the amount spent on luxury goods by a particular cardholder. In general, people with more disposable income may spend more on luxury goods and may also spend more on travel, and thus this feature may be a useful predictor of whether a time gap was anomalous (e.g., corresponding to travel). Likewise, the amount spent by a cardholder on groceries over the last week prior to travel (feature 724) and the amount spent by the cardholder on groceries over the last six months prior to travel (feature 726) may be useful for determining whether a time gap was normal or anomalous. Feature 724 is an example of a feature comprising a first cumulative amount corresponding to one or more pre-gap network event data records or one or more pre-gap training network event data records corresponding to a week long time period. Feature 726 is an example of a second cumulative amount corresponding to one or more pre-gap network event data records or one or more pre-gap training network event data records corresponding to a six month long time period. Generally, a cardholder who expects to travel may spend less on groceries in order to avoid food waste or spoilage while they are away. The amount spent in the last six months can provide a useful point of comparison, and may also correlate to travel (e.g., cardholders with more disposable income may spend more on groceries, and therefore may be more likely to engage in travel). Such features can be derived from category or industry codes contained in network event data records, along with amount values contained in network event data records, e.g., by summing the amount values corresponding to network event data records corresponding to the luxury goods industry or to the grocery category.

Feature 728 can correspond to the amount spent on groceries in a two day period following a time gap. Feature 728 is an example of a feature comprising a third cumulative amount corresponding to one or more post-gap network event data records or one or more post-gap training network event data records corresponding to a two day time period. As described above, travelers may be more likely to perform credit card transactions related to grocery purchases following a period of travel. As such, this feature may be useful in determining whether a gap is a normal time gap or an anomalous time gap. Feature 730 can correspond to the total amount spent by a cardholder in a six month period prior to travel. Like the luxury good feature (722), cardholders with greater disposable income may travel more frequently, and thus the total amount spent over a six month period may be a useful feature for determining whether a time gap corresponded to a period of travel. The computer system can derive such a feature by identifying network event data records corresponding to the grocery category (using, for example, a category data field) that also took place within the specified two week period (using, for example, timestamps or time values).

Feature 732 can correspond to the amount spent at restaurants by a cardholder in a week long period prior to a time gap. In some cases, cardholders may spend more at restaurants prior to a period of travel (in part due to reduced grocery spending). As such, this feature may be useful in determining whether a time gap was normal or anomalous. Similarly, feature 734 can correspond to the total amount spent at restaurants by a cardholder in a six month period prior to the time gap, which may be a useful point of comparison for feature 732 (e.g., determining whether the amount spent at restaurants by a cardholder in the week leading up to travel is normal given the cardholder's historical spending at restaurants). As such, this feature may be useful in determining whether a time gap is normal or anomalous. Feature 736 may correspond to a ratio of the total amount spent on food by a cardholder over a week long period and a six month period prior to the time gap. Feature 738 may correspond to a ratio of the total amount spent (in all categories) by the cardholder in a week long period and a six month period prior to the time gap. Feature 740 may correspond to a ratio of the amount spent at restaurants by a cardholder in a week long period and a six month period prior to a time gap. Feature 742 may correspond to a ratio of the amount spent by the cardholder on groceries in a two day period following a time gap and the six month period before the time gap. Each of these features may be useful in determining whether a time gap is normal or anomalous.

E. Model Training

After completing the feature extraction process, at step 510 the computer system can generate a plurality of training data samples comprising the data determined, identified, or generated during the previous steps of FIG. 5, e.g., using a plurality of training time gaps, a plurality of training labels, a plurality of pre-gap features, and a plurality of post-gap features. As described above, each training data sample can provide (e.g., identify or comprise) (1) a training time gap between two training network events, (2) a training label indicating whether the training time gap comprises a normal time gap or an anomalous time gap, (3) a set of pre-gap features corresponding to training network events that took place before the training time gap, and (4) a set of post gap features corresponding to training network events that took place after the training time gap.

Afterwards, at step 512, the computer system can train a machine learning model to classify one or more input time gaps as normal or anomalous based on one or more sets of input pre-gap features and one or more sets of post-gap features. In other words, the computer system can train a machine learning model using a set of features (i.e., the pre-gap features and post-gap features described above) to predict time periods when access requests occurred outside specified geographic regions based on patterns in the training set of historical access records that occurred before and after those time periods. In some embodiments, the machine learning model can comprise a gradient boosted decision tree model, (implemented, e.g., using XGBoost) or a neural network.

The details of this training process depend in large part on the type of machine learning model being used. In general however, the computer system can divide the labelled network event data records and extracted features into a “training set” and a “test set.” The computer system can further sub-divide the training set into “batches” or “training batches”. Then (as an example), the computer system can perform an iterative process for determining a set of model parameters defining a functional mapping between the one or more sets of pre-gap features and one or more sets of post-gap features (or feature vectors containing these pre-gap and post-gap features) and a corresponding training label. Once the training process is complete (e.g., because a predetermined number of training rounds have passed, or because the model's parameters have converged), the trained model can be used by the computer system to classify unlabeled input time gaps as normal or anomalous, based on input features corresponding to those input time gaps, as described in more detail below.

### VI. Classification

After completing model training, the computer system can then use the machine learning model to classify time gaps as normal or anomalous. This generally corresponds to step 514-522 in FIG. 5. At step 514, the computer system can retrieve an input data set comprising a plurality of input network event data records. In some cases, this plurality of network event data records could all correspond to a particular corresponding user (e.g., a particular cardholder) of a corresponding user device (e.g., a credit card, payment enabled smartphone or wearable device, etc.). In the context of a payment processing network, an entity such as an issuing bank may have identified this cardholder or their network event data records, in order to determine if that cardholder was engaging in international travel without using their credit card. In some embodiments, this plurality of network event data records may comprise or correspond to a first set of access requests for one or more first resources corresponding to a first requestor (e.g., a cardholder) and managed by the network. The first set of access requests can include first access data identifying a first resource (e.g., a particular account or computer) of the one or more first resources. The first set of access requests can include time gaps when no access requests occur.

A. Gap Identification

At step 516, the computer system can identify one or more input time gaps within the input data set. In some embodiments, each input time gap can be based on a difference between a first timestamp or time value associated with a first input network event data record and a second timestamp or second time value associated with a second event data record. The computer system can use any appropriate method to identify time gaps, including methods similar to those described with reference to the training phase.

As an example, the computer system can chronologically sort (if necessary) network event data records in the input data set. The computer system can then use timestamps or time values to determine time differences between successive network event data records in the input data set. The computer system can optionally apply or use a time duration threshold in order to identify time gaps of relevant length, as (in the context of a payment processing network, for example) short (e.g., one hour) gaps between credit card transactions are not likely to correspond to periods of international travel. In some embodiments, a time duration threshold of four days may be used. If the input data set comprises both normal and anomalous network event data records, the computer system can use methods, such as those described above with reference to FIG. 6 to identify normal and anomalous time gaps. However, presumably if machine learning is being employed to identify anomalous time gaps, it is less likely that the input data set contains anomalous data records that enable such identification without using the trained machine learning model.

B. Identifying Pre-Gap and Post-Gap Records

At step 518, the computer system can identify one or more pre-gap network event data records and one or more post-gap network event data records for each time gap identified from the input data sets. The one or more pre-gap network event data records can correspond to network events that occurred before the input time gap, and likewise the one or more post-gap network event data records can correspond to network events that occurred after the time gap. The computer system can use any appropriate method to identify the one or more pre-gap network event data records and the one or more post-gap network event data records, such as those described above with reference to training.

For example, the computer system can identify a network event data record corresponding to the start of an input time gap, then identify a predetermined pre-gap number of network event data records before that network event data record based on a chronological ordering of those network event data records. Alternatively, the computer system can identify pre-gap network event data records based on a pre-gap time range (e.g., 6 months), identifying all network event data records occurring in a six month period before the start of the input time gap. Similarly, the computer system can identify a network event data record corresponding to the end of an input time gap, then identify a predetermined post-gap number of post gap-network event data records or identify post-gap network event data records based on a post-gap time range.

C. Feature Extraction

At step 520, the computer system can determine, for each input time gap of the one or more input time gaps, a corresponding set of input pre-gap features and a corresponding set of input post-gap features. The computer system can do so by extracting the set of input pre-gap features from the one or more pre-gap network event data records and extracting the set of input post-gap features from the one more post-gap network event data records determined at step 518. Expressed in other words, the computer system can extract a plurality of first features from the first access data of the first set of access requests.

The computer system can use any appropriate feature extraction process, e.g., as described above with reference to the training phase. Such feature extraction processes can depend on the types of networks (e.g., cloud computing vs payment processing) and the definition of normal and anomalous network events and time gaps in such networks. Useful features in one context may not be applicable in other contexts. Generally, the features used during classification can be the same or similar to those used during training. As such, some or all of the exemplary features depicted in FIG. 7 may be applicable, and may be generated using substantially similar techniques to those described above (e.g., summing or averaging amount values from multiple network event data records corresponding to a particular industry or merchant category in order to produce, e.g., prior six month grocery spends for a particular cardholder).

D. Classification

Having extracted relevant pre-gap features and post-gap features for each input time gap, the computer system can now classify the input time gaps as normal or anomalous. At step 522, the computer system can classify each of the one or more input time gaps as normal or anomalous by inputting each corresponding set of input pre-gap features and each corresponding set of input post-gap features into the machine learning model, thereby determining one or more classifications. Each classification of the one or more classifications can indicate whether a corresponding input time gap of the one or more input time gaps is classified as normal or anomalous.

In some embodiments, a normal classification of the one or more classifications corresponding to the input data set can indicate a prediction that a corresponding input time gap comprises a time period during which no access requests (e.g., for the first resource) were made by a user (associated with the input data set) from outside a specified geographic region. The normal classification can be that the user was inside the specified geographic region during the time period. By contrast, an anomalous classification of the one or more classifications corresponding to the input data set can indicate a prediction that the corresponding input time gap comprises a time period during which one or more access requests to one or more other resources different than the first resource were made by the user from outside the specified geographic region. The one or more other resources can comprise one or more second accounts associated with the user. The anomalous classification can be that the user was outside the specified geographic region during the time.

E. Post-Classification

After classifying each of the one or more input time gaps as normal or anomalous, interested parties can use the one or more classifications as they see fit. For example, in the context of classifying gaps in worker node network activity (in a cloud computing network) as normal or anomalous, engineers and information technology specialists can schedule maintenance based on these classifications. Worker nodes with more anomalous time gaps (caused, e.g., by worker node crashes or failures) can be given higher maintenance priority, while worker nodes with less anomalous time gaps (indicating a lower crash or failure rate) can be given lower maintenance priority. In the context of a payment processing network, an issuing bank can use anomalous time gap classifications to identify cardholders who are not using their credit cards while travelling abroad, and can offer those cardholders incentives or perks to do so.

### VII. Computer System

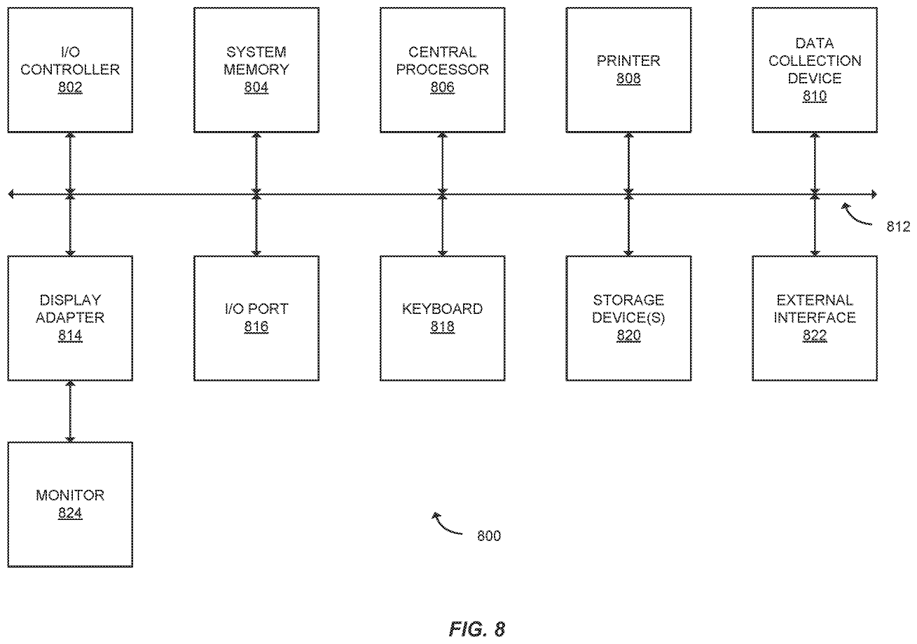

Any of the computer systems mentioned herein may utilize any suitable number of subsystems. Examples of such subsystems are shown in FIG. 8 in computer system 800. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 8 are interconnected via a system bus 812. Additional subsystems such as a printer 808, keyboard 818, storage device(s) 820, monitor 824 (e.g., a display screen, such as an LED), which is coupled to display adapter 814, and others are shown. Peripherals and input/output (I/O) devices, which couple to I/O controller 802, can be connected to the computer system by any number of means known in the art such as input/output (I/O) port 816 (e.g., USB, FireWire®). For example, I/O port 816 or external interface 822 (e.g. Ethernet, Wi-Fi, etc.) can be used to connect computer system 800 to a wide area network such as the Internet, a mouse input device, or a scanner. The interconnection via system bus 812 allows the central processor 806 to communicate with each subsystem and to control the execution of a plurality of instructions from system memory 804 or the storage device(s) 820 (e.g., a fixed disk, such as a hard drive, or optical disk), as well as the exchange of information between subsystems. The system memory 804 and/or the storage device(s) 820 may embody a computer readable medium. Another subsystem is a data collection device 810, such as a camera, microphone, accelerometer, and the like. Any of the data mentioned herein can be output from one component to another component and can be output to the user.

A computer system can include a plurality of the same components or subsystems, e.g., connected together by external interface 822, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

What is claimed is:

1. A method performed by a computer system, the method comprising:
obtaining a plurality of training data samples, each training data sample of the plurality of training data samples providing: (1) a training time gap between two training network events, each corresponding to a respective network resource, (2) a training label indicating whether the training time gap comprises a normal time gap or an anomalous time gap, (3) a set of pre-gap features corresponding to training network events that took place before the training time gap, and (4) a set of post-gap features corresponding to training network events that took place after the training time gap;
training, using the plurality of training data samples, a machine learning model to classify time gaps as normal or anomalous based on sets of input pre-gap features and sets of input post-gap features;
retrieving an input data set comprising a plurality of network event data records corresponding to a first network resource;
identifying one or more input time gaps within the input data set;
for each input time gap of the one or more input time gaps, determining a corresponding set of input pre-gap features and a corresponding set of input post-gap features; and
classifying each of the one or more input time gaps as normal or anomalous by inputting each corresponding set of input pre-gap features and each corresponding set of input post-gap features into the machine learning model, thereby determining one or more classifications, each classification of the one or more classifications indicating whether a corresponding input time gap of the one or more input time gaps is classified as normal or anomalous.

2. The method of claim 1, wherein the machine learning model comprises a gradient boosted decision tree model or a neural network.

3. The method of claim 1, wherein each set of pre-gap features and the one or more sets of input pre-gap features include one or more of the following:
a pre-gap day of a week corresponding to a pre-gap network event data record,
an pre-gap industry identifier corresponding to a resource provider associated with a pre-gap network event data record,
a pre-gap category identifier corresponding to a resource provider associated with a pre-gap network event data record,
a pre-gap time of day corresponding to a pre-gap network event data record,
a first cumulative amount corresponding to one or more pre-gap network event data records or one or more pre-gap training network event data records corresponding to a week long time period,
a second cumulative amount corresponding to one or more pre-gap network event data records or one or more pre-gap training network event data records corresponding to a six month long time period, and
a ratio of the first cumulative amount and the second cumulative amount; and
wherein each set of post-gap features and the one or more sets of input post-gap features include one or more of the following:
a post-gap day of a week corresponding to a post-gap network event data record,
a post-gap industry identifier corresponding to a resource provider associated with a post-gap network event data record,
a post-gap category identifier corresponding to a resource provider associated with a post-gap network event data record,
a post-gap time of day corresponding to a post-gap network event data record, and
a third cumulative amount corresponding to one or more post-gap network event data records or one or more post-gap training network event data records corresponding to a two day time period.

4. The method of claim 1, wherein each input time gap is defined based on a difference between a first timestamp or first time value associated with a first input network event data records and a second timestamp or second time value associated with a second input network event data record.

5. The method of claim 1, wherein determining the corresponding set of input pre-gap features and the corresponding set of input post-gap features for each input time gap comprises:
identifying one or more pre-gap network event data records from the input data set, the one or more pre-gap network event data records corresponding to network events that occurred before the input time gap;
identifying one or more post-gap network event data records from the input data set, the one or more post-gap network event data records corresponding to network events that occurred after the input time gap;
extracting the corresponding set of input pre-gap features from the one or more pre-gap network event data records; and
extracting the corresponding set of input post-gap features from the one or more post-gap network event data records.

6. The method of claim 5, wherein the one or more pre-gap network event data records comprise a predetermined pre-gap number of pre-gap network event data records or are defined by a pre-gap time range, wherein the one or more post-gap network event data records comprise a predetermined post-gap number of post-gap network event data records or are defined by a post-gap time range, wherein the pre-gap time range is less than or equal to a year, and wherein the post-gap time range is less than or equal to a year.

7. The method of claim 1, wherein:
the plurality of training data samples are derived from a plurality of training network events comprising a plurality of historical access requests for a set of resources managed by a network, each historical access request of the plurality of historical access requests including historical access data identifying a corresponding resource of the set of resources and including requestor information of a corresponding requestor; and
the plurality of network event data records comprise a plurality of access requests for a plurality of resources from the set of resources managed by the network, the plurality of network event data records including access data identifying the plurality of resources from the set of resources managed by the network, each access request including access data identifying a resource of the set of resources and including requestor information of a requestor.

8. The method of claim 7, wherein the network comprises a resource access control network, wherein the set of resources correspond to one or more resource providers, and wherein the plurality of historical access requests correspond to a plurality of historical authorization requests, the plurality of historical authorization requests requesting authorization for a plurality of interactions between a plurality of requestors and the one or more resource providers.

9. The method of claim 7, wherein the step of retrieving or generating the plurality of training data samples includes retrieving the plurality of historical access requests from a historical access request database.

10. The method of claim 7, wherein the requestor information includes a requestor credential associated with the requestor or a requestor identifier associated with the requestor.

11. The method of claim 1, wherein retrieving or generating the plurality of training data samples comprises:
retrieving a plurality of training network event data records;
identifying a plurality of training time gaps, each training time gap being between a respective first training network event corresponding to a first training network event data record of the plurality of training network event data records and a respective second training network event corresponding to a second training network event data record of the plurality of training network event data records; and
for each training time gap of the plurality of training time gaps:
determining a training label corresponding to the training time gap,
identifying one or more pre-gap training network event data records of the plurality of training network event data records, the one or more pre-gap training network event data records corresponding to training network events that occurred before the training time gap,
identifying one or more post-gap training network event data records of the plurality of training network event data records, the one or more post-gap training network event data records corresponding to training network events that occurred after the training time gap,
extracting a set of pre-gap features from the one or more pre-gap training network event data records,
extracting a set of post-gap features from the one or more post-gap training network event data records, and
generating a training data sample comprising the training time gap, the training label, the set of pre-gap features, and the set of post-gap features, thereby generating the plurality of training data samples.

12. The method of claim 11, wherein identifying the one or more pre-gap training network event data records comprises determining the one or more pre-gap training network event data records based on a chronological ordering of a plurality of training network event data records, wherein the one or more pre-gap training network event data records comprise training network event data records corresponding to training network events that occurred before the first respective training network event based on the chronological ordering.

13. The method of claim 11, wherein identifying the one or more post-gap training network event data records comprises determining the one or more post-gap training network event data records based on a chronological ordering of a plurality of training network event data records, wherein the one or more post-gap training network event data records comprise training network event data records corresponding to training network events that occurred after the second respective training network event based on the chronological ordering.

14. The method of claim 11, wherein the one or more pre-gap training network event data records comprise a predetermined pre-gap training number of pre-gap training network event data records or are defined by a pre-gap training time range, wherein the one or more post-gap training network event data records comprise a predetermined post-gap training number of post-gap training network event data records or are defined by a post-gap training time range, wherein the pre-gap training time range is less than or equal to a year, and wherein the post-gap training time range is less than or equal to a year.

15. The method of claim 11, further comprising chronologically sorting the plurality of training network event data records based on a plurality of timestamps or a plurality of time values corresponding to the plurality of training network event data records.

16. The method of claim 11, wherein the first training network event data record comprises a first normal training network event data record, wherein the second training network event data record comprises a second normal training network event data record, and wherein determining a training label comprises:
determining if there are one or more intervening anomalous training network event data records between the first normal training network event data record and the second normal training network event data record; and
if there are one or more intervening anomalous training network event data records between the first normal training network event data record and the second normal training network event data record, determining the training label as an anomalous training label, otherwise determining the training label as a normal training label.

17. The method of claim 1, wherein the plurality of training data samples are derived from a plurality of training network event data records, wherein the plurality of training data samples comprise one or more normal training data samples and one or more anomalous training data samples, wherein the plurality of training network event data records comprise one or more normal training network event data records and one or more anomalous training network event data records, wherein a normal training network event data record comprises a network event data record corresponding to an access request made by a training user from within a specified geographic region, and wherein an anomalous training network event data record corresponds to an access request made by a training user from outside the specified geographic region.

18. The method of claim 17, wherein:
each training data sample of the plurality of training data samples corresponds to a corresponding training user and a corresponding training network resource, wherein the corresponding training network resource comprises a corresponding training user account,
the first network resource corresponding to the plurality of network event data records of the input data set comprises a first user account associated with a user,
a normal training label provided by a corresponding training data sample indicates that a corresponding training time gap comprises a time period during which no historical access requests were made by the corresponding training user of the corresponding training user account from outside the specified geographic region,
an anomalous training label provided by a corresponding training data sample indicates that a corresponding training time gap comprises a time period during which one or more historical access requests were made by the corresponding training user of the corresponding training user account from outside the specified geographic region,
a normal classification of the one or more classifications corresponding to the input data set indicates a prediction that the corresponding input time gap comprises a time period during which no access requests were made by the user from outside the specified geographic region, and
an anomalous classification of the one or more classifications corresponding to the input data set indicates a prediction that the corresponding input time gap comprises a time period during which one or more access requests to one or more other resources were made by the user from outside the specified geographic region.

19. A method performed by one or more processors of a computer system, the method comprising:
receiving historical access requests for a set of resources managed by a network, each historical access request including access data identifying a resource of the set of resources and including requestor information of a requestor;
identifying a plurality of time periods in the historical access requests for when the historical access requests are made from devices outside of a specified geographic region;
generating a training set of the historical access requests that occur before and after each time period of the plurality of time periods;
extracting a set of features from the access data of the training set of the historical access requests;
training, using the set of features, a machine learning model to predict the time period when access requests occur from outside the specified geographic region based on a pattern of the training set of the historical access requests that occur before and after the time periods;
receiving a first set of access requests for one or more first resources corresponding to a first requestor and managed by the network, the first set of access requests including first access data identifying a first resource of the one or more first resources and including first requestor information of the first requestor, wherein the first set of access requests include time gaps when no access requests occur;
extracting a plurality of first features from the first access data of the first set of access requests; and
determining, by inputting the plurality of first features into the machine learning model, whether one or more of the time gaps occurred when the requestor was outside of the specified geographic region.

20. A computer system comprising:
one or more processors; and
a non-transitory computer readable medium coupled to the one or more processors, the non-transitory computer readable medium comprising code or instructions, executable by the one or more processors for performing a method comprising:
obtaining a plurality of training data samples, each training data sample of the plurality of training data samples providing: (1) a training time gap between two training network events, each corresponding to a respective network resource, (2) a training label indicating whether the training time gap comprises a normal time gap or an anomalous time gap, (3) a set of pre-gap features corresponding to training network events that took place before the training time gap, and (4) a set of post-gap features corresponding to training network events that took place after the training time gap;
training, using the plurality of training data samples, a machine learning model to classify time gaps as normal or anomalous based on sets of input pre-gap features and sets of input post-gap features;
retrieving an input data set comprising a plurality of network event data records;
identifying one or more input time gaps within the input data set;
for each input time gap of the one or more input time gaps, determining a corresponding set of input pre-gap features and a corresponding set of input post-gap features; and
classifying each of the one or more input time gaps as normal or anomalous by inputting each corresponding set of input pre-gap features and each corresponding set of input post-gap features into the machine learning model, thereby determining one or more classifications, each classification of the one or more classifications indicating whether a corresponding input time gap of the one or more input time gaps is classified as normal or anomalous.
